(19) United States
(12) Patent Application Publication
(10) Pub. No.: US 2021/0305557 A1
(43) Pub. Date: Sep. 30, 2021

(54) ANODES AND METHODS OF MAKING AND USING THEREOF

(71) Applicant: Ohio State Innovation Foundation, Columbus, OH (US)

(72) Inventors: Anne CO, Columbus, OH (US); Julen BASCARAN, Columbus, OH (US); Pamela Cristina SMECELLATO, Sao Paulo (BR); Jose Lorie LOPEZ, Columbus, OH (US); Daniel Joseph LYONS, Edmond, OK (US)

(21) Appl. No.: 17/265,086

(22) PCT Filed: Aug. 1, 2019
(86) PCT No.: PCT/US2019/044759

§ 371 Date: Feb. 1, 2021

Related U.S. Application Data
(60) Provisional application No. 62/713,137, filed on Aug. 1, 2018.

(51) Int. Cl. H01M 4/485; H01M 4/505; H01M 4/58; H01M 4/525; H01M 10/0525; H01M 4/131; H01M 4/38

(52) U.S. Cl. CPC H01M 4/485; H01M 4/505; H01M 4/5825; H01M 4/525; H01M 2004/021; H01M 4/131; H01M 4/386; H01M 4/387; H01M 10/0525

(57) ABSTRACT

Disclosed are amorphous glasses, anodes comprising particles formed from these amorphous glasses, and electrochemical cells (e.g., batteries) comprising these anodes. The amorphous glass can be formed from a mixture comprising two or more active components and two or more amorphous forming components.

### CROSS-REFERENCE TO RELATED APPLICATIONS

This application claims benefit of U.S. Provisional Application No. 62/713,137, filed Aug. 1, 2018, which is hereby incorporated herein by reference in its entirety.

### BACKGROUND

Lithium-ion batteries are used in applications that need high energy or power densities. In addition to electronic portable equipment such as cellular phones, tablets, laptops and digital cameras, these density characteristics make them ideal for electric vehicles (EV). Typically, recharging these batteries takes much longer than refueling the average liquid-fueled vehicle. However, consumer demand will ultimately call for an electric refueling experience similar in duration to that of a liquid-fueled vehicle, i.e., less than 10 minutes. Likewise, faster charging for consumer portable electronics is desired.

Battery research and development over the last decade or more has focused on increasing the energy density of the battery cell via higher capacity materials and thicker electrodes. However, it is difficult for these thicker electrode systems to perform at higher charge rates. Degradation of thicker electrodes can occur more rapidly if charged too quickly when compared to thinner-coated electrodes. Slower charge rates are needed in order to allow the lithium-ions to reach all storage sites of the active material on the electrode. In general, the more storage sites per unit area a material has, the more time is required for those sites to accept lithium ions. Charging at too high of a rate runs the risk of exposing those materials to lithium ions at a rate they are unable to accept. This results in lithium plating on the surface of the anode, increased battery temperature, and other detrimental side chemical reactions that decrease life and performance characteristics.

During charging, lithium ions move from the cathode electrode and intercalate, or get inserted, into the anode electrode or react with the anode to form a stable structure. As the charge rate increases, lithium ions move from the cathode into the anode at a faster rate. At high charging rates, and typically at high state of charge (SOC), the lithium ions cannot move into the anode material because the available storage sites are filled or nearly filled and intercalation or the anode reaction slows down. As a result, lithium ions deposit, or plate, as lithium metal on the surface of the anode. Lithium plating can lead to dendrite growth, increases in resistance, and potentially a short circuit.

There are many anode chemistries with varying degrees of technology maturity. Carbon-based anodes such as graphite are some of the most prolific materials in the lithium-ion battery industry. However, when graphite is lithiated during recharge, the electrochemical potential of the electrode can become very low. Therefore, lithium plating can more easily occur, especially as the battery is charged at a fast rate and also as the battery approaches the fully charged state. Lithium titanate (LTO) possesses a higher potential and lower density when fully lithiated compared to graphite, suggesting that lithium plating is more difficult. LTO can be suitable for repeatedly and reliably charging at rates as high as 10C. New anode chemistries are currently being studied, but none have matured to a state of being viable candidates for extreme fast charging. For example, silicon offers advantages for fast charge in the form of reduced anode thickness due to very high areal capacity when compared with a graphite anode, but electrodes containing silicon for fast charge applications are still underdeveloped and of unknown viability.

State-of-the-art high-energy battery cell technology is capable of delivering 200 Wh/kg at 2C (30 minutes) charging. The main limitation is charging a graphite anode at rates higher than this can significantly degrade battery life and safety due to lithium plating and increased battery temperatures. The Department of Energy (DOE) has called for the next generation of fast charge battery cells, referred to as extreme fast charging, to be greater than 2 Ah, and to be capable of achieving 500 6C charge/1C discharge cycles with <20% fade in specific energy delivered (i.e., charge acceptance) from fast charge protocol, while achieving or improving state-of-the-art cell specific energy and cost. The charge rate does not need to be constant current, but the charge protocol must be finished within 10 minutes. The DOE's specification is for the charge protocol to deliver ≥180 Wh/kg of stored energy to the cell at the beginning of life (i.e., initial cell characterization testing). The energy delivered is determined by discharging a fast charged cell at the C/3 rate to a defined minimum voltage. Upon completion of 500 6C charge*/1C discharge cycles the battery must have <20% fade in specific energy delivered from the fast charge protocol (i.e., ≥144 Wh/kg).

There is thus a need to meet or exceed the specifications for a next generation extreme fast charging lithium ion battery.

### SUMMARY

Provided herein are anodes that comprise particles formed from an amorphous glass. The amorphous glass can be formed from a mixture comprising two or more active components and two or more amorphous forming components.

The particle size and particle size distribution of the particles can vary. In some cases, the particles can have an aspect ratio of 10 or less, such as an aspect ratio of 5 or less or an aspect ratio of 2 or less. In certain embodiments, the particles can be substantially spherical in shape.

In certain embodiments, the particles comprise a monodisperse population of particles.

In some embodiments, the particles can comprise a population of microparticles. For example, in some embodiments, the particles can comprise a population of microparticles can have an average particle size of from 1 micron to 15 microns (e.g., from 1 micron to 5 microns), as determined by scanning electron microscopy (SEM). In other embodiments, the particles can comprise a population of nanoparticles. For example, in some embodiments, the population of nanoparticles has an average particle size of from 25 nm to less than 1 micron (e.g., from 100 nm to 750 nm), as determined by scanning electron microscopy (SEM).

The two or more active components can comprise from 51 mol % to 99 mol % (e.g., from 80 mol % to 95 mol % of the amorphous glass. The two or more amorphous forming components can comprise from 1 mol % to 49 mol % (e.g., from 5 mol % to 25 mol %, or from 5 mol % to 20 mol %) of the amorphous glass. The two or more active components and the two or more amorphous forming components can be present in the amorphous glass at a molar ratio of from 1.1:1 to 50:1, such as from 1.1:1 to 25:1, from 2:1 to 25:1, from 2:1 to 20:1, from 4:1 to 20:1, from 5:1 to 15:1, or from 5:1 to 10:1.

The two or more active components can comprise silicon, tin, lead, antimony, germanium, gallium, indium, bismuth, or any combination thereof. In some embodiments, the two or more active components can comprise silicon. In some embodiments, the two or more active components can comprise tin.

In certain embodiments, the amorphous glass can comprise a SiSn-based glass (e.g., a glass that comprises silicon, tin, optionally one or more additional active components, and two or more amorphous forming components). In the case of SiSn-based amorphous glasses, the two or more active components comprise silicon and tin, and the silicon and the tin can be present a molar ratio of from 1.1:1 to 20:1 (e.g., from 2:1 to 15:1 or from 3:1 to 12:1).

The two or more amorphous forming components can comprise electrochemically inactive components that favor glass formation. Examples of suitable amorphous forming components include iron, aluminum, titanium, copper, nickel, cobalt, manganese, zirconium, yttrium, boron, niobium, molybdenum, tungsten, or any combination thereof.

In some embodiments, the two or more amorphous forming components can comprise one or more lanthanides. For example, the one or more lanthanides comprise from 1 mol % to 25 mol % (e.g., from 5 mol % to 20 mol % or from 10 mol % to 20 mol %) of the amorphous glass.

In some embodiments, the two or more amorphous forming components can comprise one or more Group 4 elements. For example, the one or more Group 4 elements can comprise from 1 mol % to 15 mol % (e.g., from 1 mol % to 10 mol % or from 2 mol % to 8 mol %) of the amorphous glass.

In some embodiments, the two or more amorphous forming components comprise one or more Group 13 elements. For example, the one or more Group 13 elements can comprise from 1 mol % to 8 mol % (e.g., from 2 mol % to 6 mol % or from 3 mol % to 4 mol %) of the amorphous glass.

In some embodiments, the amorphous glass comprises a glass defined by the formula below

SiₓSn_{y}¹AFMₐ²AFM_{b}³AFM_{c}⁴AFM_{d}

wherein ¹AFM, ²AFM, ³AFM, and ⁴AFM represent different elements, each chosen from iron, aluminum, titanium, copper, nickel, cobalt, manganese, gallium, indium, zirconium, and yttrium; x is from 50 to 90; y is from 1 to 40; a is from 0.5 to 20; b is from 0.5 to 15; c is from 0 to 10; and d is from 0 to 10.

In some examples, the amorphous glass can comprise a SiSnCeFeAlTi glass (e.g., Si₆₀Sn₁₂Ce₁₈Fe₅Al₃Ti₂).

In some examples, the amorphous glass can comprise a SiSnFeAlTi glass (e.g., Si₇₃Sn₁₅Fe₆Al₄Ti₂).

In some examples, the amorphous glass can comprise a SiSnAlTi glass (e.g., Si₇₈Sn₁₆Al₄Ti₂).

The particles can be formed by a variety of suitable methods. In some embodiments, the particles can be formed by micronization of a bulk solid material. For example, the particles can be formed by ball milling or other suitable milling process. In other embodiments, the particles can be formed by a templating process. Suitable templating processes can employ a porous membrane or a self-assembled array of spherical particles as a template to control particle size. For example, the templating process can comprises imbibing a precursor solution comprising a metal precursor into a template; and calcining the template.

Optionally, in some embodiments, the particles can further comprise a carbonaceous material disposed on a surface of the particles.

The particles can be dispersed in a binder. In some cases, the binder can comprise a polymeric binder such as vinylidene fluoride (PVDF), polyaniline, or a combination thereof. In some embodiments, the polymeric binder can comprise a conductive polymer. In some cases, the binder can comprise a carbonaceous material such as carbon black.

Also provided are electrochemical cells that include the anodes described herein. For example, provided are electrochemical cells that comprise an anode described herein, a cathode, and an electrolyte disposed between the anode and the cathode. In certain cases, the electrochemical cell can comprise a lithium ion battery, and the cathode comprises a lithium-based cathode (e.g., lithium iron phosphate, LiNi₁₋ₓMn_{x/2}Coₓ/2O₂, wherein x=0.4 or 0.2, or LiNi_{0.8}Co_{0.15}Al_{0.05}O₂)

In some embodiments, the electrochemical cell can exhibit an energy density of at least 180 Wh/kg at room temperature.

In some embodiments, the electrochemical cell can exhibit a charge rate of from 1 minute to 10 minutes to 30% of a state of charge (SOC), a charge rate of from 1 minute to 10 minutes to 50% of a state of charge (SOC), a charge rate of from 1 minute to 10 minutes to 70% of a state of charge (SOC), and/or a charge rate of from 1 minute to 10 minutes to 90% of a state of charge (SOC).

Also provided are populations of particles formed from an amorphous glass. The amorphous glass can comprise a glass defined by the formula below

SiₓSn_{y}¹AFMₐ²AFM_{b}³AFM_{c}⁴AFM_{d}

wherein ¹AFM, ²AFM, ³AFM, and ⁴AFM represent different elements, each chosen from iron, aluminum, titanium, copper, nickel, cobalt, manganese, gallium, indium, zirconium, and yttrium; x is from 50 to 90; y is from 1 to 40; a is from 0.5 to 20; b is from 0.5 to 15; c is from 0 to 10; and d is from 0 to 10.

The particle size and particle size distribution of the particles can vary. In some cases, the particles can have an aspect ratio of 10 or less, such as an aspect ratio of 5 or less or an aspect ratio of 2 or less. In certain embodiments, the particles can be substantially spherical in shape.

In certain embodiments, the particles comprise a monodisperse population of particles.

In some embodiments, the particles can comprise a population of microparticles. For example, in some embodiments, the particles can comprise a population of microparticles can have an average particle size of from 1 micron to 15 microns (e.g., from 1 micron to 5 microns), as determined by scanning electron microscopy (SEM). In other embodiments, the particles can comprise a population of nanoparticles. For example, in some embodiments, the population of nanoparticles has an average particle size of from 25 nm to less than 1 micron (e.g., from 100 nm to 750 nm), as determined by scanning electron microscopy (SEM).

The two or more active components can comprise from 51 mol % to 99 mol % (e.g., from 80 mol % to 95 mol % of the amorphous glass. The two or more amorphous forming components can comprise from 1 mol % to 49 mol % (e.g., from 5 mol % to 25 mol %, or from 5 mol % to 20 mol %) of the amorphous glass. The two or more active components and the two or more amorphous forming components can be present in the amorphous glass at a molar ratio of from 1.1:1 to 50:1, such as from 1.1:1 to 25:1, from 2:1 to 25:1, from 2:1 to 20:1, from 4:1 to 20:1, from 5:1 to 15:1, or from 5:1 to 10:1.

### DESCRIPTION OF DRAWINGS

FIG. 1 shows the X-ray diffraction patterns for compositions listed in Table 1 (from top to bottom Sn₉₄Al₄Ti₂, Si₉₄Al₄Ti₂, Si₇₈Sn₁₆Al₄Ti₂, Si₇₃Sn₁₅Fe₆Al₄Ti₂, and Si₆₀Sn₁₂Ce₁₈Fe₅Al₃Ti₂), as well as diffraction patterns for corresponding species (Sn, SnO₂, SnO, SiO₂, and FeSi).

FIG. 2 shows backscatter scanning electron microscopy (SEM) images of (panel a) Si₇₈Sn₁₆Al₄Ti₂ active particle before casting (panel a), an enlargement of the surface of the active particle (panel b), and EDS images of the SEM image shown in panel b, scanning for the elements Si (panel c), Al (panel d), Sn (panel e), and Ti (panel f).

FIG. 3A shows an SEM micrograph of bulk Si₇₃Sn₁₅Fe₆Al₄Ti₂.

FIG. 3B shows an SEM micrograph of a non-porous PHB membrane.

FIG. 3C and FIG. 3D show SEM micrographs of porous PHB membrane prepared using a phase inversion method.

FIG. 3E and FIG. 3F show SEM micrographs of porous PHB membrane prepared using a phase inversion method during the templated synthesis of amorphous metal particles.

FIG. 3G shows an SEM micrograph of porous PHB membrane prepared using polystyrene nanospheres.

FIG. 3H and FIG. 3I show SEM micrographs of porous PHB membrane prepared using polystyrene nanospheres during the templated synthesis of amorphous metal particles.

FIG. 4A is a plot showing the results of rate capability tests for compositions listed in Table 1 at rates ranging from C/2 to 60C.

FIG. 4B is a plot showing the results of rate capability tests for compositions listed in Table 2 at rates ranging from C/2 to 60C.

FIG. 4C is a plot showing capacity as a function of percent Sn within the compositions listed in Table 2. Capacity was taken from the final point at each rate for each composition.

FIG. 5A shows a long term cyclability plot for ball milled and unmilled amorphous metal at a charge rate of 13C. Cells cycled from 0.05 to 3 V vs. Li/Li⁺.

FIG. 5B is a plot showing the results of rate capability tests for ball milled and unmilled material at rates ranging from C/2 to 60C. Cells cycled from 0.05 to 3 V vs. Li/Li⁺.

FIG. 6 is a plot showing the comparative charge/discharge cycling data of the Si₇₃Sn₁₅Al₄Ti₂Fe₆, Si₇₃Sn₁₅Al₄Ti₂Fe₆—SR1, Si₇₃Sn₁₅Al₄Ti₂Fe₆—SR2 and Si₇₃Sn₁₅Al₄Ti₂Fe₆—SR3 recorded at a current density of 6C, in a 1 mol L⁻¹ LiPF₆ in EC/DMC 1:1 V/V solution.

FIG. 7 is a plot showing the capacity of Si₇₃Sn₁₅Al₄Ti₂Fe₆—SR3 at a current density of 6C for electrodes with different mass of active material, in a 1 mol L⁻¹ LiPF₆ in EC/DMC 1:1 V/V solution.

FIG. 8 is a plot illustrating the long-term cyclability of Si₇₃Sn₁₅Al₄Ti₂Fe₆.

FIG. 9A and FIG. 9B show the capacity of from 0.32 mg of Si₇₃Sn₁₅Al₄Ti₂Fe₆ (FIG. 9A) or 0.4 mg of Si₇₃Sn₁₅Al₄Ti₂Fe₆ (FIG. 9B) at a current density 6C for 1000 cycles in a 1 mol L⁻¹ LiPF₆ in EC:DMC 1:1 V/V solution.

FIG. 10A and FIG. 10B show rate varying in electrodes prepared from 0.3 mg of Si₇₃Sn₁₅Al₄Ti₂Fe₆—SR3 (FIG. 10A) or 1.02 mg of Si₇₃Sn₁₅Al₄Ti₂Fe₆—SR3 (FIG. 10B) in a 1 mol L⁻¹ LiPF₆ in EC:DMC 1:1 V/V solution.

FIG. 11 is a cyclic voltammogram for a lithium and Si₇₈Sn₁₆Al₄Ti₂ half cell, cycled at 5 mV/s, 2.5 mV/s, 1 mV/s, 0.5 mV/s, 0.25 mV/s, at 0.1 mV/s from 3 V to 0.005 V.

FIG. 12 is a cyclic voltammogram for a sodium and Si₇₈Sn₁₆Al₄Ti₂ half cell, cycled at 35 V/s from 3 V to 0.005 V.

FIG. 13 is a rate performance plot of Si₆₀Sn₁₂Ce₁₈Fe₅Al₃Ti₂ and Si₇₈Sn₁₆Al₄Ti₂. Two sets of each composition shown in respective shades. Sodium half cells cycled at rates of C/24, C/10, and C/3.

FIG. 14A shows the charge/discharge profile for a full cell containing LiFePO₄ as the working electrode and the amorphous metal as the counter and reference, cycled at a rate of C/6.

FIG. 14B shows the charge/discharge cycling data for the full cell, cycled at a rate of 10C in the potential range of 1 to 3.5V vs. Li/Li⁺.

FIG. 15A shows the charge/discharge profile for a full cell containing LiFePO₄ as the working electrode and the amorphous metal as the counter and reference, cycled at a rate of C/10.

FIG. 15B shows the charge/discharge cycling data for the full cell, cycled at a rate of 10C in the potential range of 0.005 to 4.5V vs. Li/Li⁺.

FIG. 16A and FIG. 16B show charge/discharge cycling data for a full cell containing an amorphous metal anode and reference with NIC (FIG. 16A) and NCA (FIG. 16B) as the working electrode. Cells were cycled between 0.05 and 4.5 V vs Li/Li+ at a rate of 10C.

### DETAILED DESCRIPTION

Unless otherwise indicated, the abbreviations used herein have their conventional meaning within the chemical arts.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) can includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B). The phrases “combinations thereof” and “any combinations thereof are used synonymously herein.

As used herein, the terms “active component” and “active material” are used synonymously, and refer to a material that reacts with a working ion (e.g., lithium) under conditions typically encountered during charging and discharging of a battery (e.g., a lithium ion battery). Two or more active components can be present as the majority components of the amorphous glasses described herein.

As used herein, the terms “inactive component” and “inactive material” are used synonymously, and refer to a material that does not react with a working ion (e.g., lithium) under conditions typically encountered during charging and discharging of a battery (e.g., a lithium ion battery). Two or more inactive components can be present as minority components of the amorphous glasses described herein.

As used herein, the term “metal” refers to both metals and metalloids such as silicon and germanium. The metal is often in an elemental state.

As used herein, the term “lithiation” refers to the process of adding lithium to an amorphous glass described herein (i.e., lithium ions are reduced). Likewise, the term “sodiation” refers to an analogous process where sodium is added to an amorphous glass described herein.

As used herein, the term “delithiation” refers to the process of removing lithium from an amorphous glass described herein (i.e., lithium ions are oxidized). Likewise, the term “desodiation” refers to an analogous process where sodium is removed from an amorphous glass described herein.

As used herein, the term “charging” refers to a process of providing electrochemical energy to a battery.

As used herein, the term “discharging” refers to a process of removing electrochemical energy from a battery (i.e., discharging is a process of using the battery to do useful work).

As used herein, the term “cathode” refers to the electrode where electrochemical reduction occurs during the discharging process. During discharging, the cathode undergoes lithiation. During charging, lithium atoms are removed from this electrode.

As used herein, the term “anode” refers to the electrode where electrochemical oxidation occurs during the discharging process. During discharging, the anode undergoes delithiation. During charging, lithium atoms are added to this electrode.

“Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

Provided herein are anodes that comprise particles formed from an amorphous glass. The amorphous glass can be formed from a mixture comprising two or more active components and two or more amorphous forming components.

The particle size and particle size distribution of the particles can vary. The particles can have any suitable shape or combination of shapes. For example, the particles can have an oblate shape, a prolate shape, a bladed shape, an equant shape, or a combination thereof. In some embodiments, the particles can be non-fibrous. Elongate particles and fibers can be characterized in terms of their aspect ratio. “Aspect ratio,” as used herein, refers to the length divided by the diameter of a particle or fiber. In some cases, the particles can have an aspect ratio of 10 or less, such as an aspect ratio of 5 or less or an aspect ratio of 2 or less. In certain embodiments, the particles can be substantially spherical in shape.

The population of particles can have an average particle size. “Average particle size” and “mean particle size” are used interchangeably herein, and generally refer to the statistical mean particle size of the particles in a population of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. For particles having non-spherical shapes, the diameter of a particle can refer, for example, to the smallest cross-sectional dimension of the particle (i.e., the smallest linear distance passing through the center of the particle and intersecting two points on the surface of the particle). Mean particle size can be measured using methods known in the art, such as evaluation by scanning electron microscopy (SEM), transmission electron microscopy, and/or dynamic light scattering.

In some embodiments, the particles can comprise a population of microparticles. For example, in some embodiments, the particles can comprise a population of microparticles having an average particle size of at least 1 micron (e.g., at least 2 microns, at least 3 microns, at least 4 microns, at least 5 microns, at least 6 microns, at least 7 microns, at least 8 microns, at least 9 microns, at least 10 microns, at least 11 microns, at least 12 microns, at least 13 microns, or at least 14 microns), as determined by SEM. In some embodiments, the particles can comprise a population of microparticles having an average particle size of 15 microns or less (e.g., 14 microns or less, 13 microns or less, 12 microns or less, 11 microns or less, 10 microns or less, 9 microns or less, 8 microns or less, 7 microns or less, 6 microns or less, 5 microns or less, 4 microns or less, 3 microns or less, or 2 microns or less), as determined by SEM.

The particles can comprise a population of microparticles having an average particle size ranging from any of the minimum values described above to any of the maximum values described above. For example, in some embodiments, the particles can comprise a population of microparticles having an average particle size of from 1 micron to 15 microns (e.g., from 1 micron to 5 microns), as determined by SEM.

In some embodiments, the particles can comprise a population of nanoparticles. For example, in some embodiments, the particles can comprise a population of nanoparticles having an average particle size of at least 25 nm (e.g., at least 50 nm, at least 100 nm, at least 150 nm, at least 200 nm, at least 250 nm, at least 300 nm, at least 350 nm, at least 400 nm, at least 450 nm, at least 500 nm, at least 550 nm, at least 600 nm, at least 650 nm, at least 700 nm, at least 750 nm, at least 800 nm, at least 850 nm, at least 900 nm, or at least 950 nm), as determined by SEM. In some embodiments, the particles can comprise a population of nanoparticles having an average particle size of less than 1 micron (e.g., 950 nm or less, 900 nm or less, 850 nm or less, 800 nm or less, 750 nm or less, 700 nm or less, 650 nm or less, 600 nm or less, 550 nm or less, 500 nm or less, 450 nm or less, 400 nm or less, 350 nm or less, 300 nm or less, 250 nm or less, 200 nm or less, 150 nm or less, 100 nm or less, or 50 nm or less), as determined by SEM.

The particles can comprise a population of nanoparticles having an average particle size ranging from any of the minimum values described above to any of the maximum values described above. For example, in some embodiments, the particles can comprise a population of microparticles having an average particle size of from 25 nm to less than 1 micron (e.g., from 100 nm to 750 nm), as determined by SEM.

In some embodiments, the population of particles is a monodisperse population of particles. In other embodiments, the population of particles is a polydisperse population of particles. In some instances where the population of particles is monodisperse, greater that 50% of the particle size distribution, more preferably 60% of the particle size distribution, most preferably 75% of the particle size distribution lies within 10% of the median particle size.

In some embodiments, the two or more active components can comprise at least 51 mol % (e.g., at least 55 mol %, at least 60 mol %, at least 65 mol %, at least 70 mol %, at least 75 mol %, at least 80 mol %, at least 85 mol %, at least 90 mol %, or at least 95 mol %) of the amorphous glass. In some embodiments, the two or more active components can comprise 99 mol % or less (e.g., 95 mol % or less, 90 mol % or less, 85 mol % or less, 80 mol % or less, 75 mol % or less, 70 mol % or less, 65 mol % or less, 60 mol % or less, or 55 mol % or less).

The two or more active components can be present in the amorphous glass in an amount ranging from any of the minimum values described above to any of the maximum values described above. For example, in some embodiments, the two or more active components can comprise from 51 mol % to 99 mol % (e.g., from 80 mol % to 95 mol % of the amorphous glass.

In some embodiments, the two or more amorphous forming components can comprise at least 1 mol % (e.g., at least 5 mol %, at least 10 mol %, at least 15 mol %, at least 20 mol %, at least 25 mol %, at least 30 mol %, at least 35 mol %, at least 40 mol %, or at least 45 mol %) of the amorphous glass. In some embodiments, the two or more amorphous forming components can comprise 49 mol % or less (e.g., 45 mol % or less, 40 mol % or less, 35 mol % or less, 30 mol % or less, 35 mol % or less, 20 mol % or less, 25 mol % or less, 10 mol % or less, or 5 mol % or less).

The two or more amorphous forming components can be present in the amorphous glass in an amount ranging from any of the minimum values described above to any of the maximum values described above. For example, in some embodiments, the two or more amorphous forming components can comprise from 1 mol % to 49 mol % (e.g., from 5 mol % to 25 mol %, or from 5 mol % to 20 mol %) of the amorphous glass.

The two or more active components and the two or more amorphous forming components can be present in the amorphous glass at a molar ratio of from 1.1:1 to 50:1, such as from 1.1:1 to 25:1, from 2:1 to 25:1, from 2:1 to 20:1, from 4:1 to 20:1, from 5:1 to 15:1, or from 5:1 to 10:1.

The two or more active components can comprise silicon, tin, lead, antimony, germanium, gallium, indium, bismuth, or any combination thereof. In some embodiments, the two or more active components can comprise silicon, tin, antimony, germanium, or any combination thereof. In some embodiments, the two or more active components can comprise silicon. In some embodiments, the two or more active components can comprise tin.

In certain embodiments, the amorphous glass can comprise a SiSn-based glass (e.g., a glass that comprises silicon, tin, optionally one or more additional active components, and two or more amorphous forming components). In the case of SiSn-based amorphous glasses, the two or more active components comprise silicon and tin, and the silicon and the tin can be present a molar ratio of from 1.1:1 to 20:1 (e.g., from 2:1 to 15:1 or from 3:1 to 12:1).

The two or more amorphous forming components can comprise electrochemically inactive components that favor glass formation. In some cases, suitable amorphous forming components can include, but are not limited to, transition metals, rare earth metals, or a combination thereof. Examples of suitable amorphous forming components include iron, aluminum, titanium, copper, nickel, cobalt, manganese, zirconium, yttrium, boron, niobium, molybdenum, tungsten, or any combination thereof. Other possible amorphous forming components can include chromium, tantalum, lanthanum, cerium, and Misch metal (i.e., a mixture of rare earth metals).

In some embodiments, the two or more amorphous forming components can comprise one or more lanthanides. For example, the one or more lanthanides comprise from 1 mol % to 25 mol % (e.g., from 5 mol % to 20 mol % or from 10 mol % to 20 mol %) of the amorphous glass.

In some embodiments, the two or more amorphous forming components can comprise one or more Group 4 elements. For example, the one or more Group 4 elements can comprise from 1 mol % to 15 mol % (e.g., from 1 mol % to 10 mol % or from 2 mol % to 8 mol %) of the amorphous glass.

In some embodiments, the two or more amorphous forming components comprise one or more Group 13 elements. For example, the one or more Group 13 elements can comprise from 1 mol % to 8 mol % (e.g., from 2 mol % to 6 mol % or from 3 mol % to 4 mol %) of the amorphous glass.

In some embodiments, the amorphous glass comprises a glass defined by the formula below

SiₓSn_{y}¹AFMₐ²AFM_{b}³AFM_{c}⁴AFM_{d}

wherein ¹AFM, ²AFM, ³AFM, and ⁴AFM represent different elements, each chosen from iron, aluminum, titanium, copper, nickel, cobalt, manganese, gallium, indium, zirconium, and yttrium; x is from 50 to 90; y is from 1 to 40; a is from 0.5 to 20; b is from 0.5 to 15; c is from 0 to 10; and d is from 0 to 10.

In some embodiments, x can be at least 50 (e.g., at least 55, at least 60, at least 65, at least 70, at least 75, at least 80, or at least 85). In some embodiments, x can be 90 or less (e.g., 85 or less, 80 or less, 75 or less, 70 or less, 65 or less, 60 or less, or 55 or less).

In some cases, x can range from any of the minimum values described above to any of the maximum values described above. For example, in some embodiments, x can be from 50 to 90 (e.g., from 60 to 80).

In some embodiments, y can be at least 1 (e.g., at least 5, at least 10, at least 15, at least 20, at least 25, at least 30, or at least 35). In some embodiments, y can be 40 or less (e.g., 35 or less, 30 or less, 25 or less, 20 or less, 15 or less, 10 or less, or 5 or less).

In some cases, y can range from any of the minimum values described above to any of the maximum values described above. For example, in some embodiments, y can be from 1 to 40 (e.g., from 5 to 20).

In some embodiments, a can be at least 0.5 (e.g., at least 1, at least 2.5, at least 5, at least 7.5, at least 10, or at least 15). In some embodiments, a can be 20 or less (e.g., 15 or less, 10 or less, 7.5 or less, 5 or less, 2.5 or less, or 1 or less).

In some cases, a can range from any of the minimum values described above to any of the maximum values described above. For example, in some embodiments, a can be from 0.5 to 20 (e.g., from 2.5 to 15).

In some embodiments, b can be at least 0.5 (e.g., at least 1, at least 2.5, at least 5, at least 7.5, or at least 10). In some embodiments, b can be 15 or less (e.g., 10 or less, 7.5 or less, 5 or less, 2.5 or less, or 1 or less).

In some cases, b can range from any of the minimum values described above to any of the maximum values described above. For example, in some embodiments, b can be from 0.5 to 15 (e.g., from 2.5 to 10).

In some embodiments, c can be greater than 0 (e.g., at least 0.5, at least 1, at least 2.5, at least 5, or at least 7.5). In some embodiments, c can be 10 or less (e.g., 7.5 or less, 5 or less, 2.5 or less, 1 or less, or 0.5 or less).

In some cases, c can range from any of the minimum values described above to any of the maximum values described above. For example, in some embodiments, c can be from 0 to 10 (e.g., from 2.5 to 7.5).

In some embodiments, d can be greater than 0 (e.g., at least 0.5, at least 1, at least 2.5, at least 5, or at least 7.5). In some embodiments, d can be 10 or less (e.g., 7.5 or less, 5 or less, 2.5 or less, 1 or less, or 0.5 or less).

In some cases, d can range from any of the minimum values described above to any of the maximum values described above. For example, in some embodiments, d can be from 0 to 10 (e.g., from 2.5 to 7.5).

In some examples, the amorphous glass can comprise a SiSnCeFeAlTi glass (e.g., Si₆₀Sn₁₂Ce₁₈Fe₅Al₃Ti₂).

In some examples, the amorphous glass can comprise a SiSnFeAlTi glass (e.g., Si₇₃Sn₁₅Fe₆Al₄Ti₂).

In some examples, the amorphous glass can comprise a SiSnAlTi glass (e.g., Si₇₈Sn₁₆Al₄Ti₂).

The particles can be formed by a variety of suitable methods. In some embodiments, the particles can be formed by micronization of a bulk solid material. For example, the particles can be formed by ball milling or other suitable milling process. In other embodiments, the particles can be formed by a templating process. Suitable templating processes can employ a porous membrane or a self-assembled array of spherical particles as a template to control particle size. For example, the templating process can comprises imbibing a precursor solution comprising a metal precursor into a template; and calcining the template.

Optionally, in some embodiments, the particles can further comprise a carbonaceous material disposed on a surface of the particles.

In some embodiments, the particles can further comprise a carbonaceous material (e.g., residue from the pyrolysis of a polymeric template in which the particles were formed).

The particles (formed from an amorphous glass) described herein can be dispersed in any suitable binder material to form an anode. In some embodiments, the binder can comprise a polymeric binder. The polymeric binder can comprise a conductive polymer, a non-conductive polymer, or a combination thereof. In some embodiments, the anode can comprise particles described herein dispersed in an elastomeric polymer binder. Suitable elastomeric polymer binders include polyolefins such as those prepared from ethylene, propylene, or butylene monomers; polyanilines; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of elastomeric polymer binders include terpolymers of vinylidene fluoride (PVDF), tetrafluoroethylene, and propylene; and copolymers of vinylidene fluoride and hexafluoropropylene. Commercially available fluorinated elastomers include those sold by Dyneon, LLC, Oakdale, Minn. under the trade designation “FC-2178”, “FC-2179”, and “BRE-731X”.

In certain cases, the binder can comprise a polymeric binder such as vinylidene fluoride (PVDF), polyaniline, or a combination thereof. In some embodiments, the polymeric binder can comprise a conductive polymer.

If desired for the construction of a particular anode, the binder can be crosslinked. Crosslinking can improve the mechanical properties of the polymer and/or can improve the contact between the particles and any electrically conductive diluent that may be present.

Optionally, an electrically conductive diluent can be added to facilitate electron transfer from the particles to a current collector. Examples of electrically conductive diluents include, but are not limited to, carbon, metal, metal nitrides, metal carbides, metal silicides, and metal borides. In some anodes, the electrically conductive diluents can be carbon blacks such as those commercially available from MMM Carbon of Belgium under the trade designation “SUPER P” and “SUPER S” and from Chevron Chemical Co. of Houston, Tex. under the trade designation “SHAWANIGAN BLACK”; acetylene black; furnace black; lamp black; graphite; carbon fibers; or combinations thereof. In some cases, the binder can comprise a carbonaceous material such as carbon black.

The anode can further include an adhesion promoter that promotes adhesion of the particles and the electrically conductive diluent to the polymer binder. The combination of an adhesion promoter and polymer binder accommodates, at least partially, volume changes that may occur in the alloy composition during repeated cycles of lithiation and delithiation. The adhesion promoter can be part of the binder (e.g., in the form of a functional group) or can be in the form a coating on the alloy composition, the electrically conductive diluent, or a combination thereof. Examples of adhesion promoters include, but are not limited to, silanes, titanates, and phosphonates as described in U.S. Patent Application 2003/0058240, the disclosure of which is incorporated herein by reference.

Any suitable electrolyte can be included in the lithium ion battery. The electrolyte can be in the form of a solid or liquid. Exemplary solid electrolytes include polymeric electrolytes such as polyethylene oxide, polytetrafluoroethylene, polyvinylidene fluoride, fluorine-containing copolymers, polyacrylonitrile, or combinations thereof. Exemplary liquid electrolytes include ethylene carbonate, dimethyl carbonate, diethyl carbonate, propylene carbonate, gamma-butyrolactone, tetrahydrofuran, 1,2-dimethoxyethane, dioxolane, or combinations thereof. The electrolyte includes a lithium electrolyte salt such as LiPF₆, LiBF₄, LiClO₄, LiN(SO₂CF₃)₂, LiN(SO₂CF₂CF₃)₂, and the like.

The electrolyte can include a redox shuttle molecule, an electrochemically reversible material that during charging can become oxidized at the cathode, migrate to the anode where it can become reduced to reform the unoxidized (or less-oxidized) shuttle species, and migrate back to the cathode. Suitable redox shuttle molecules include, for example, those described in U.S. Pat. No. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 B1 (Lain et al.); and in PCT Published Patent Application No. WO 01/29920 A1 (Richardson et al.).

Any suitable cathode known for use in lithium ion batteries can be utilized. Some exemplary cathodes in a charged state contain lithium atoms intercalated within a lithium transition metal oxide such as lithium cobalt dioxide, lithium nickel dioxide, and lithium manganese dioxide. Other exemplary cathodes are those disclosed in U.S. Pat. No. 6,680,145 B2 (Obrovac et al.), incorporated herein by reference. That is, the cathode can contain particles that include transition metal grains (e.g., iron, cobalt, chromium, nickel, vanadium, manganese, copper, zinc, zirconium, molybdenum, niobium, or combinations thereof) having a grain size no greater than about 50 nanometers in combination with lithium-containing grains selected from lithium oxides, lithium sulfides, lithium halides (e.g., chlorides, bromides, iodides, or fluorides), or combinations thereof. These particles can be used alone or in combination with a lithium-transition metal oxide material such as lithium cobalt dioxide.

In some lithium ion batteries with solid electrolytes, the cathode can include LiV₃O₈ or LiV₂O₅. In other lithium ion batteries with liquid electrolytes, the cathode can include LiCoO₂, LiCo_{0.2}Ni_{0.8}O₂, LiMn₂O₄, LiFePO₄, or LiNiO₂.

In certain cases, the electrochemical cell can comprise a lithium ion battery, and the cathode comprises a lithium-based cathode (e.g., lithium iron phosphate, LiNi₁₋ₓMn_{x/2}Coₓ/2O₂, wherein x=0.4 or 0.2, or LiNi_{0.8}Co_{0.15}Al_{0.05}O₂).

The lithium ion batteries can be used as a power supply in a variety of applications. For example, the lithium ion batteries can be used in power supplies for electronic devices such as computers and various hand-held devices, motor vehicles, power tools, photographic equipment, and telecommunication devices. Multiple lithium ion batteries can be combined to provide a battery pack.

In some embodiments, the electrochemical cell can exhibit an energy density of at least 180 Wh/kg at room temperature.

In some embodiments, the electrochemical cell can exhibit a charge rate of from 1 minute to 10 minutes to 30% of a state of charge (SOC), a charge rate of from 1 minute to 10 minutes to 50% of a state of charge (SOC), a charge rate of from 1 minute to 10 minutes to 70% of a state of charge (SOC), and/or a charge rate of from 1 minute to 10 minutes to 90% of a state of charge (SOC).

Also provided are populations of particles formed from an amorphous glass. The amorphous glass can comprise a glass defined by the formula below

SiₓSn_{y}¹AFMₐ²AFM_{b}³AFM_{c}⁴AFM_{d}

wherein ¹AFM, ²AFM, ³AFM, and ⁴AFM represent different elements, each chosen from iron, aluminum, titanium, copper, nickel, cobalt, manganese, gallium, indium, zirconium, and yttrium; x is from 50 to 90; y is from 1 to 40; a is from 0.5 to 20; b is from 0.5 to 15; c is from 0 to 10; and d is from 0 to 10.

In some embodiments, x can be at least 50 (e.g., at least 55, at least 60, at least 65, at least 70, at least 75, at least 80, or at least 85). In some embodiments, x can be 90 or less (e.g., 85 or less, 80 or less, 75 or less, 70 or less, 65 or less, 60 or less, or 55 or less).

In some cases, x can range from any of the minimum values described above to any of the maximum values described above. For example, in some embodiments, x can be from 50 to 90 (e.g., from 60 to 80).

In some embodiments, y can be at least 1 (e.g., at least 5, at least 10, at least 15, at least 20, at least 25, at least 30, or at least 35). In some embodiments, y can be 40 or less (e.g., 35 or less, 30 or less, 25 or less, 20 or less, 15 or less, 10 or less, or 5 or less).

In some cases, y can range from any of the minimum values described above to any of the maximum values described above. For example, in some embodiments, y can be from 1 to 40 (e.g., from 5 to 20).

In some embodiments, a can be at least 0.5 (e.g., at least 1, at least 2.5, at least 5, at least 7.5, at least 10, or at least 15). In some embodiments, a can be 20 or less (e.g., 15 or less, 10 or less, 7.5 or less, 5 or less, 2.5 or less, or 1 or less).

In some cases, a can range from any of the minimum values described above to any of the maximum values described above. For example, in some embodiments, a can be from 0.5 to 20 (e.g., from 2.5 to 15).

In some embodiments, b can be at least 0.5 (e.g., at least 1, at least 2.5, at least 5, at least 7.5, or at least 10). In some embodiments, b can be 15 or less (e.g., 10 or less, 7.5 or less, 5 or less, 2.5 or less, or 1 or less).

In some cases, b can range from any of the minimum values described above to any of the maximum values described above. For example, in some embodiments, b can be from 0.5 to 15 (e.g., from 2.5 to 10).

In some embodiments, c can be greater than 0 (e.g., at least 0.5, at least 1, at least 2.5, at least 5, or at least 7.5). In some embodiments, c can be 10 or less (e.g., 7.5 or less, 5 or less, 2.5 or less, 1 or less, or 0.5 or less).

In some cases, c can range from any of the minimum values described above to any of the maximum values described above. For example, in some embodiments, c can be from 0 to 10 (e.g., from 2.5 to 7.5).

In some embodiments, d can be greater than 0 (e.g., at least 0.5, at least 1, at least 2.5, at least 5, or at least 7.5). In some embodiments, d can be 10 or less (e.g., 7.5 or less, 5 or less, 2.5 or less, 1 or less, or 0.5 or less).

In some cases, d can range from any of the minimum values described above to any of the maximum values described above. For example, in some embodiments, d can be from 0 to 10 (e.g., from 2.5 to 7.5).

In some examples, the amorphous glass can comprise a SiSnCeFeAlTi glass (e.g., Si₆₀Sn₁₂Ce₁₈Fe₅Al₃Ti₂).

In some examples, the amorphous glass can comprise a SiSnFeAlTi glass (e.g., Si₇₃Sn₁₅Fe₆Al₄Ti₂).

In some examples, the amorphous glass can comprise a SiSnAlTi glass (e.g., Si₇₈Sn₁₆Al₄Ti₂).

The particle size and particle size distribution of the particles can vary. In some cases, the particles can have an aspect ratio of 10 or less, such as an aspect ratio of 5 or less or an aspect ratio of 2 or less. In certain embodiments, the particles can be substantially spherical in shape.

In certain embodiments, the particles comprise a monodisperse population of particles.

In some embodiments, the particles can comprise a population of microparticles. For example, in some embodiments, the particles can comprise a population of microparticles can have an average particle size of from 1 micron to 15 microns (e.g., from 1 micron to 5 microns), as determined by scanning electron microscopy (SEM). In other embodiments, the particles can comprise a population of nanoparticles. For example, in some embodiments, the population of nanoparticles has an average particle size of from 25 nm to less than 1 micron (e.g., from 100 nm to 750 nm), as determined by scanning electron microscopy (SEM).

The two or more active components can comprise from 51 mol % to 99 mol % (e.g., from 80 mol % to 95 mol % of the amorphous glass. The two or more amorphous forming components can comprise from 1 mol % to 49 mol % (e.g., from 5 mol % to 25 mol %, or from 5 mol % to 20 mol %) of the amorphous glass. The two or more active components and the two or more amorphous forming components can be present in the amorphous glass at a molar ratio of from 1.1:1 to 50:1, such as from 1.1:1 to 25:1, from 2:1 to 25:1, from 2:1 to 20:1, from 4:1 to 20:1, from 5:1 to 15:1, or from 5:1 to 10:1.

By way of non-limiting illustration, examples of certain embodiments of the present disclosure are given below.

### EXAMPLES

### Example 1. Extreme Fast Charging Batteries Through Design of Materials and Cell Architectures

In this example, the effect of the inactive matrix composition on the lithiation performance is explored (Table 1). After the relevant elements in the inactive matrix were identified, the SiₓSn_{y} composition (Table 2) was varied to establish the relationship between SiₓSn_{y} composition Li-ion battery anode performance.

TABLE 1
Amorphous metal compositions used in electrodes, prepared
by removing elements from the composition.

| Number | Composition |
|---|---|
| 1 | Si₆₀Sn₁₂Ce₁₈Fe₅Al₃Ti₂ |
| 2 | Si₇₃Sn₁₅Fe₆Al₄Ti₂ |
| 3 | Si₇₈Sn₁₆Al₄Ti₂ |
| 4 | Si₉₄Al₄Ti₂ |
| 5 | Sn₉₄Al₄Ti₂ |

TABLE 2
Amorphous metal compositions used in electrodes, gradually
adjusting the atomic percent of Sn and Si.

| Composition | Atomic Percent Sn | Atomic Percent Si |
|---|---|---|
| Si₉₀Sn₄Al₄Ti₂ | 4 | 90 |
| Si₈₆Sn₈Al₄Ti₂ | 8 | 86 |
| Si₇₈Sn₁₆Al₄Ti₂ | 16 | 78 |
| Si₄₇Sn₄₇Al₄Ti₂ | 47 | 47 |
| Si₁₆Sn₇₈Al₄Ti₂ | 78 | 16 |
| Si₀Sn₉₄Al₄Ti₂ | 94 | 0 |

Starting from Si₆₀Sn₁₂Ce₁₈Fe₅Al₃Ti₂, an incremental removal of each element gradually increased the atomic percent of Si within the amorphous alloy shown in Table 1. The electrochemical performance indicated that Si₇₈Sn₁₆Al₄Ti₂ displayed the highest capacity at each charge rate. Therefore, this composition was selected for further processing and optimization. Gradual removal of each element gave insight into each element's role in lithiation efficiency. Further, the removal of Sn from the overall composition resulted in a dramatic drop in cell capacity at all rates, implying that Sn plays a significant role in this system. Electrochemical performance of the anode was evaluated with compositions containing 0-94 mol % Si, 0-94 mol % Sn, 0-18 mol % of a lanthanide element, 0-8 mol % (e.g., 3-4 mol %) Al, Ga, In, or a combination thereof, 0-10 mol % (e.g., 2-8 mol %) of one or more Group IV transition metals.

Table 1 summarizes the composition of the amorphous materials investigated in this example. Each amorphous composition was generally composed of Si and Sn, which can lithiate and can be used anodes in Li-ion batteries, within an inactive matrix comprising Fe, Ti, and Al, and/or Ce. Addition of inactive elements of varying atomic radii can induce the formation of an amorphous phase, which is beneficial for cycling stability at increased rates. Si based ternary metallic glass alloys composed of Si-M₁-M₂ (M₁=Sn,Al, or transition metals in 20-40 atomic %; M₂=lanthanum or cerium in 15-20 atomic %) have been reported. In these alloys, the Si and Sn act as the main lithium storage centers, while the additional transition metals and lanthanides act as elements to enable the formation of an amorphous matrix through atomic size mismatching. The formation of an amorphous matrix prevents the crystallization of Si, which mitigates the volume expansion experienced by its lithiation. In addition, the presence of micro to nano crystalline regions of Sn embedded within the amorphous matrix can facilitate efficient lithiation within the electrode by acting as a conduction path for lithium ions.

Materials and Methods

Materials. Polyhydroxybutyrate porous membrane were prepared through phase inversion of a polymer solution of poly[(R)-3-hydroxybutyric acid] (PHB, Sigma Aldrich) and chloroform (99.9%, Fisher Scientific). For a phase inversion bath solution, chloroform and ethanol (100%, Decon Labs, Inc., USA) were used.

The PHB porous membrane obtained by polystyrene nanospheres was prepared with PHB solution in ethylene carbonate (EC, Sigma Aldrich) (3:2 w/w) and addition of dimethyl carbonate (DMC, Sigma Aldrich). Separately, a suspension with a 2.6% solid (w/v) aqueous solution of polystyrene nanospheres (100 nm diameter, Polysciences, Inc., USA) was placed in distilled water and TritonX-100 (Acros Organics, USA). Tetrahydrofuran (TIF 99.9%, Sigma Aldrich) was used as a dissolving agent for the polystyrene spheres.

All compositions of amorphous metals were prepared using the following reagents. Tin(II) chloride (SnCl₂, 98%, Sigma-Aldrich Co., Ltd., USA), 3-aminopropyltriethoxysilane (C₉H₂₃NO₃Si, ≥98%, Sigma-Aldrich Co., Ltd., USA), aluminum chloride hexahydrate (AlCl₃.6H₂O, 99%, Sigma-Aldrich Co., Ltd., USA), titanium(IV) butoxide (Ti[O(CH₂)₃CH₃]₄, 99%, Acros Organics, USA), iron(III) nitrate nonahydrate (Fe(NO₃)₃.9H₂O, ≥98%, Sigma-Aldrich Co., Ltd., USA), and cerium(III) acetate hydrate (Ce(CH₃CO₂)₃.H₂O, 99.9%, Sigma-Aldrich Co., Ltd., USA). A mixture of 3.5 g of N,N-dimethylformamide (DMF, MCB Reagents, Germany) and 5 g of distilled water and 0.5 g of acetic acid (99%, Ricca Chemical Co., USA) were used as solvents to dissolve the metal salts.

Synthesis of PHB Porous Membranes by Phase Inversion. A polymer solution was prepared by dissolving 6% w/w polyhydroxybutyrate (Sigma Aldrich) in chloroform (Fisher Scientific) at 90° C. and under constant magnetic stirring for 1 hour. Thin films of PHB were obtained by spin-coating (2500 rpm, 30 s) the polymer solution on top of steel plate substrates. The substrate containing the PHB solution was submerged in a non-solvent bath (ethanol/chloroform, 9:1 v/v) for the humid phase inversion. During this process, the non-solvent comes in contact with the PHB film. With the increment of the concentration of the non-solvent inside the films, a gelation process is initiated that results in the formation of membranes with porous morphology.

Synthesis of PHB Porous Membranes using Polystyrene Nanospheres. The polymer solution was prepared by dissolving PHB in Ethylene Carbonate (EC, Sigma Aldrich) (3:2 w/w) and addition of Dimethyl Carbonate (DMC, Sigma Aldrich) to ensure a viscose solution, at 120° C. and under constant magnetic stirring for 30 min. Then, a suspension solution was prepared adding 0.2 mL of 2.6% solid (w/v) aqueous solution polystyrene nanospheres 100 nm diameter (500 nm diameter spheres were also used for comparing different pore sizes) in 0.3 mL of distilled water and 2 μL TritonX-100. The nanosphere suspension was deposited on a glass substrate and allowed to dry in air. Sequentially, the dry layer of nanospheres was coated with the PHB solution and allowed to dry in air again. The membrane of PHB with polystyrene nanospheres was placed in a Tetrahydrofuran (THF 99.9%, Sigma Aldrich) bath for 2 hours for complete dissolution of the spheres leaving a porous membrane.

Bulk Amorphous Metal Alloy Synthesis. All metal alloy compositions were synthesized using the following procedure. Reagents were added to a vial and dissolved with the mixture of DMF, water, acetic acid, and sonicated for 10 min until all components are dissolved. Three milliliters of the solution was transferred to a quartz boat and thermally heated in a tube furnace to 700° C. for 2 h under a slightly reducing atmosphere (5% H₂, 95% Ar). The boat was then removed from the tube furnace to air quench. The resulting alloy was ground into a fine powder with a mortar and pestle, or further processed in a DECO-0.4L planetary ball mill (Changsha Deco Equipment Co., Ltd.). Four grams of the as synthesized material was placed within an agate (99.9% SiO₂) jar with agate balls at a ratio of 15:1 balls to powder. The jar was sealed and milled at a rotation speed of 1100 rpm for 75 hours.

Template Synthesis. For template synthesis, the previously obtained porous membranes were submerged into a metal solution (e.g., a solution of Si₇₃Sn₁₅Al₄Ti₂Fe₆) for 24 hours to ensure complete soaking. Subsequently, the wet membranes were calcinated at 700° C. for 2 hours in tube furnace (TF55030A-1, Lindberg/Blue M^{M}) under reducing atmosphere (5% H₂, 95% Ar) using a quartz boat. Additionally, samples of amorphous metal alloys (e.g., Si₇₃Sn₁₅Al₄Ti₂Fe₆) were also prepared without spatial restriction by directly placing the metal solution into the furnace under same conditions.

Material Characterization. Investigation into the presence of any crystalline phases within the amorphous metals was conducted through the use of an X-ray diffractometer (XRD, D8 Advance, Bruker) with Cu Kα (λ=1.54059 Å) radiation. The morphology of the material was investigated by scanning electron microscopy (SEM, Apreo LoVac High Resolution, FEI), and the elemental analysis was conducted with energy-dispersive X-ray spectroscopy (EDS). The thermal properties of the materials are analyzed through TGA-DTG and DSC techniques. For the TGA-DTG analyses, a Q50 TGA from TA Instruments is used under a flowing (50 mL min⁻¹) N₂ atmosphere, in the temperature range of 25 to 900° C. and at a heating rate of 10° C. min⁻¹. For DSC analysis, a Q20 DSC (TA Instruments) is used under a flowing (50 mL min⁻¹) N₂ atmosphere, in the temperature range of 25 to 600° C. and at a heating ramp of 10° C. min⁻¹

Electrode Preparation. The electrodes used in all electrochemical experiments were prepared by combining the ground alloy into a slurry composed of 80-90 wt % active material, 5-10 wt % carbon black (Carbon Vulcan Black XC-72R), 5-10 wt % polyvinylidene fluoride (PVDF, MTI Corp.), and N-methyl-2-pyrrolidone (NMP, MTI Corp.) as a solvent. The slurry was cast on a thin copper foil (9 μm thick, MTI Corp.) at a thickness of 0.3 mm using a doctor-blade coating system (MSK-AFA I, MTI Corp.). The cast film was dried in a vacuum oven at 100° C. for 3-12 hours. Electrodes of 12.5 mm diameters were punched, massed, and transferred to an Ar filled glovebox (mBraun) with continuous detection of O₂ (<0.5 ppm) and H₂O (<0.5 ppm).

Electrochemical Characterization. The electrodes were assembled into two electrode CR2032 coin cells. A high purity lithium metal (0.3 mm thick, Chemetall Foote Corp.) was used as the combined counter and reference electrode. For sodium cells, a high purity sodium metal was used as the combined counter and reference electrode. Celgard™ 2400 soaked in electrolyte was used as the separator. For lithium cells, lithium phosphohexafluoride (LiPF₆) in a 1:1 volume mixture of ethyl carbonate and dimethyl carbonate (Purolyte A5 Series, Novolyte Technologies) was used as the electrolyte. For sodium cells, sodium phosphohexafluoride (NaPF₆) in a 1:1 volume mixture of ethyl carbonate and dimethyl carbonate was used as the electrolyte. Full cell experiments were conducted using CR2032 coin cells with the amorphous metal as the anode, and the commercial material of choice as the cathode in excess. Commercial cathodes selected were LiFePO₄ (LiFePO₄, MTI Corp.), Lithium Nickel Cobalt Aluminum Oxide (NCA, LiNiCoAlO₂, Ni:Co:Al=8.15:1.5:0.35, MTI Corp.), and Lithium Nickel Cobalt Manganese Oxide (NMC, LiNiCoMnO₂, Ni:Co:Mn=8:1:1, MTI Corp.).

Chronopotentiometric experiments were performed at increasing current densities of 40.5 mA/g, 81 mA/g, 135 mA/g, 148 mA/g, 183 mA/g, 254 mA/g, 400 mA/g, 405 mA/g, 800 mA/g, 1000 mA/g, 1200 mA/g, 1227 mA/g 1500 mA/g, 2025 mA/g and 2382 mA/g. Lithium half cell cutoff potentials were 0.005V to 3V (vs. Li/Li⁺). Sodium half-cell cutoff potentials were 0.005V to 3V (vs. Na/Na⁺). Lithium ion full cell cutoff potentials were 0.005V to 3V (vs. Li/Li⁺), as well as 0.005V to 4.5V (vs. Li/Li⁺). Constant current experiments were performed using a multichannel VMP3 bipotentiostat (BioLogic, Grenoble, FR). All experiments were performed at room temperature. Cyclic voltammetry (CV) experiments for lithium half cells were performed with a potential window of 0.005V to 3V (vs. Li/Li⁺). Voltage sweep rates used were 0.1 mV/s, 0.25 mV/s, 0.5 mV/s, 1 mV/s, 2.5 mV/s, and 5 mV/s. CV experiments for sodium half cells were performed with a potential window of 0.005V to 3V (vs. Na/Na⁺) at a sweep rate of 35 V/s.

Materials Characterization Results

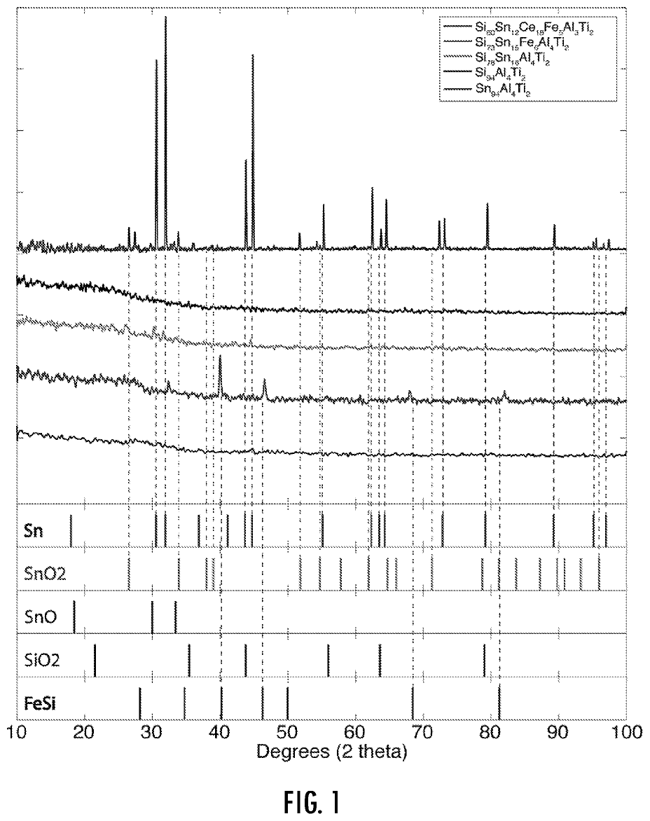

X-Ray Diffraction. FIG. 1 shows the diffraction patterns for each composition in Table 1, the oxides for each potentially electrochemically active species, as well as additional species that match peaks seen in the diffraction patterns. The diffraction pattern of the original Si₆₀Sn₁₂Ce₁₈Fe₅Al₃Ti₂ composition demonstrates a lack of peaks indicative of and amorphous metal. The removal of the cerium from the original composition results in the formation of large peaks at 39.8°, 46.3°, 67.7°, and 81.8°, which can be attributed to an FeSi intermetallic phase that forms between Fe and Si above 500° C. Further removal of the Fe component from the composition results in the disappearance of these large peaks, and the formation of small peaks at angles equivalent to those of the β-Sn. For reference, peak positions of the β-Sn phase are shown at the bottom the figure as solid black lines. These relatively low intensity peaks in the Si₇₈Sn₁₆Al₄Ti₂ diffraction pattern are attributed to the formation of crystalline Sn within an otherwise amorphous network. In addition, the peak at 26° is associated to the presence of Sn₀₂ within the alloy. The presence of this species was also confirmed using XPS (see below).

Finally, the diffraction pattern of Si₉₄Al₄Ti₂ shows no peaks, indicating the resulting composition is amorphous. This is consistent with the patterns from previous compositions, in that all crystalline phases were formed from Fe or Sn, therefore the absence of these elements would prevent the formation of any crystalline phases, manifested as peaks in the diffraction spectra.

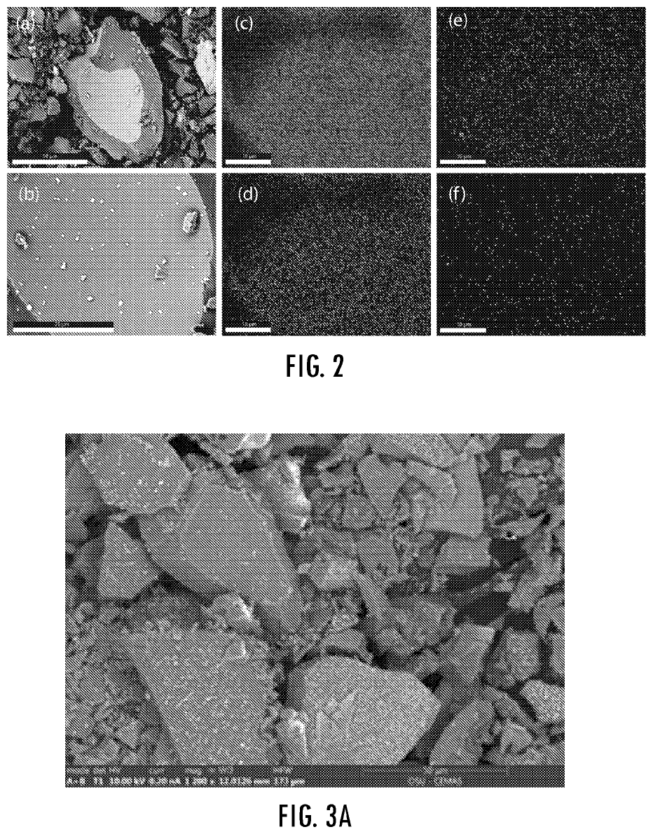

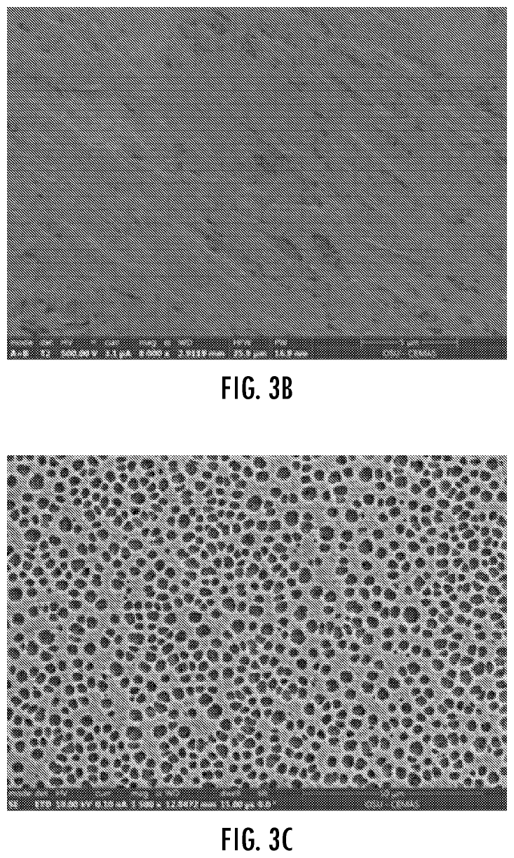

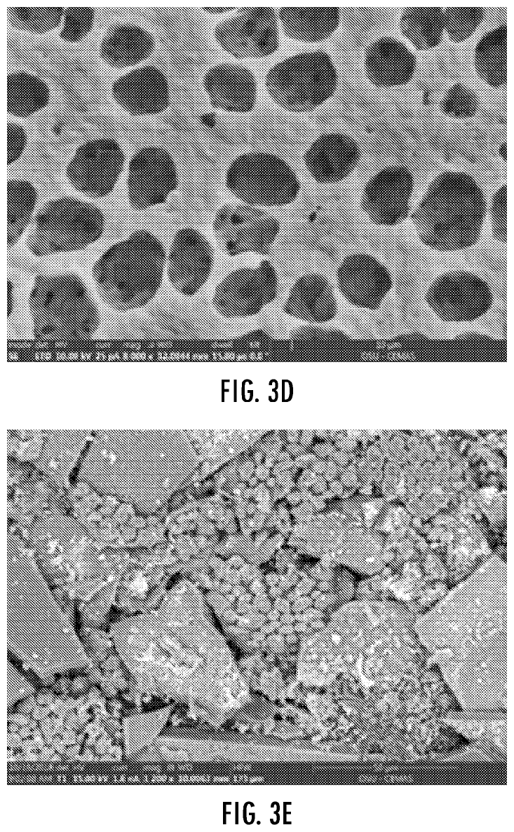

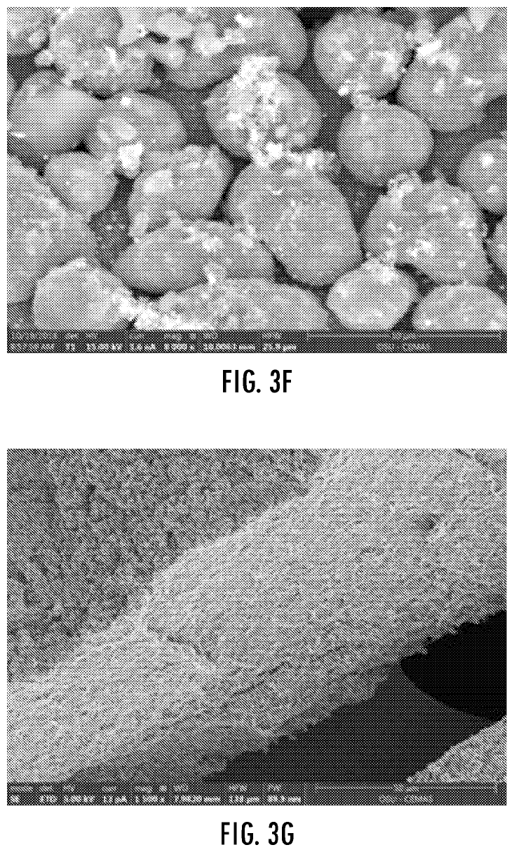

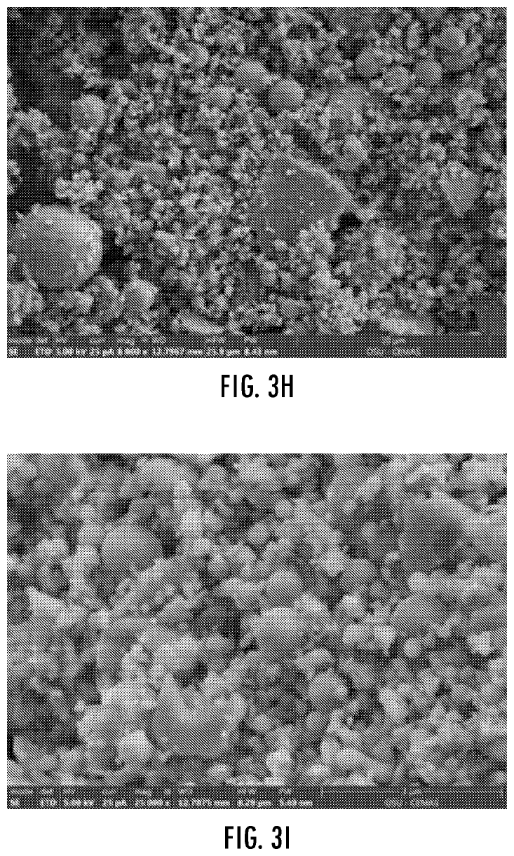

Scanning Electron Microscopy and Energy Dispersive X-ray Spectroscopy of Si₇₈Sn₁₆Al₄Ti₂ (Bulk). Scanning electron microscopy images taken of the amorphous metal prior to cycling was used to gain initial insight into the surface morphology of the particles prior to casting and lithiation. As the synthesized product was ground with a mortar and pestle, the resulting product contains grains with a distribution of sizes, ranging from tens of microns, to sub-micron lengths. Regardless of the size of the grain, it was noted that each has a flat surface, free of pores or additional surface features. This is further emphasized by focusing on two larger grains seen in FIG. 2, panel a, which demonstrates that the faces are devoid of any porous structuring. An additional image is taken closer to the surface of the larger grain seen in FIG. 2, panel b. The surface, though lacking in any porous structure, contains micron sized particulates seen as brighter spots on the surface. The use of a backscatter electron detector implies that the increased brightness of the particulates is due to their composition being made up of heavier elements, the heaviest in this composition being Sn.

To determine the distribution of elements throughout the electrode surface, energy dispersive x-ray spectroscopy is used. Focusing on the surface seen in FIG. 2, panel b, all four compositional elements were scanned for. Si displays a uniform distribution throughout the electrode surface implying an amorphous distribution, with the exception of locations where brighter spots were observed in the backscatter SEM images. Al displays a relatively uniform distribution as well lacking any distinct localizations, though like Si, it was not present where bright spots were visible in the SEM. Ti appeared to be uniformly distributed throughout the electrode, however, due to the low atomic percent within the composition, it was difficult to identify any potential agglomerations of Ti within the sample. Finally, Sn displayed a relatively uniform distribution over the electrode surface, however, where more intense spots were visible in the SEM image, there appeared to be localization of Sn in the same positions. This indicated that Sn has formed agglomerations on the surface, existing independently from the rest of the amorphous distribution. This finding was consistent with the diffraction pattern seen in FIG. 1, as less intense Sn peaks exist within the otherwise amorphous signal. It is clear from the SEM image seen in FIG. 2, panel b, that these localizations of Sn exist below the surface as well, implying that microcrystalline regions of Sn may be distributed throughout the active particles.

Scanning Electron Microscopy and Energy Dispersive X-ray Spectroscopy of Si₇₈Sn₁₆Al₄Ti₂ (Ball Milled Material). To improve the performance of the anode at accelerated discharge rates, the raw material was further processed through ball-milling in order to minimize the size of the active particles, thus minimizing the diffusion distance of the lithium ions. Ball milling of the raw material resulted in a dramatic decrease in particle size, with the average size decreasing from 10 um to 370 nm. The raw material contained the aforementioned large features, which would prevent rapid diffusion of lithium ions, and therefore limit the fast charging ability of the anode. However further processing creates much smaller features within the electrode, with some particles measuring as small as 30 nm in diameter. These nano-sized active particles, along with the amorphous nature of the active material created a system much more conducive to rapid charging and discharging. Extensive ball milling resulted in aggregations of smaller particles; however, this was not expected to detrimentally affect battery performance. Despite ball milling, some particles remained micron sized, with some measuring between 2 and 3 microns in diameter. These larger particles could be seen to lithiate comparably to the active particles in the electrodes pre-ball milling due to their large size

Electrochemical Performance of Lithium Half Cells

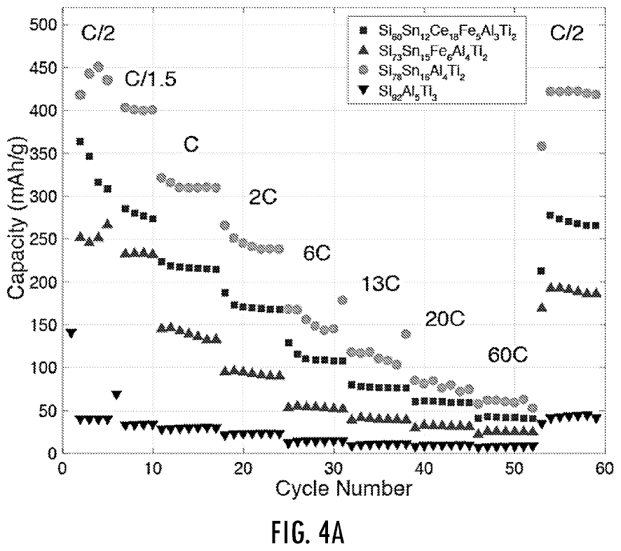

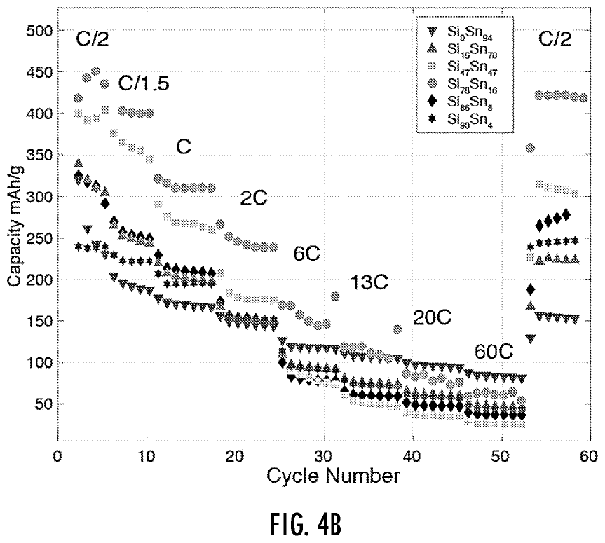

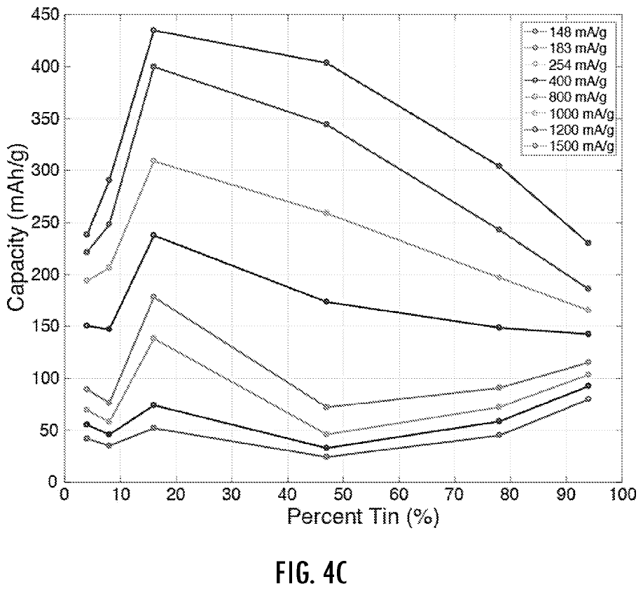

Performance as Composition is Adjusted. To investigate the rate capabilities of each composition, galvanostatic charge-discharge tests were conducted at current densities ranging from 148 mA/g to 1500 mA/g as seen in FIG. 4A. Due to the unknown nature of the material's theoretical capacity, the C-rate was deemed as the amount of time required for the voltage to reach the minimum and maximum of the window, thus either fully charging, or discharging the battery. The current densities corresponding to specific discharge rates ranging from C/2 to 60C can be seen in the table below.

| Gravimetric Current | Areal Current Density | Mean time | |
|---|---|---|---|
| Density (mA/g) | (mA/cm\hat{ }2) | (min) | Real C rate |
| 148 | 0.4824 | 120 | C/2 |
| 183 | 0.5965 | 90 | C/1.5 |
| 254 | 0.8279 | 60 | C |
| 400 | 1.3038 | 30 | 2 C |
| 800 | 2.6076 | 10 | 6 C |
| 1000 | 3.2595 | 4.6 | 13 C |
| 1200 | 3.9114 | 3 | 20 C |
| 1500 | 4.8892 | 1 | 60 C |

The capacity of each electrode was normalized to the weight of only the active material within the electrode. The weight of the carbon additive, as well as PVDF binder were not factored into the weight normalization. Through all current densities, it was evident that the composition of Si₇₈Sn₁₆Al₄Ti₂ demonstrated consistently higher capacity than all other compositions. As shown in FIG. 4A, at 148 mA/g, composition 3 demonstrated a specific capacity of 434.8 mA h g-1, exhibiting 29% higher capacity than composition 1, 39% higher capacity than composition 2, and 91% higher capacity than composition 4. As seen in FIG. 4A, this trend continued through all current densities. On average over all current densities, composition 3 performs 28% better than composition 1, 54% better than composition 2, and 89% better than composition 4. Additionally, composition 3 demonstrates minimal irreversible capacity loss, with only 4% lost after accelerated charge discharge tests.

The removal of cerium from the initial composition resulted in a visible drop in capacity overall charge rates. This drop can most likely be attributed to the presence of the FeSi species visible in the diffraction pattern of composition 2. This crystalline phase can irreversibly alloy with lithium resulting in a dramatic capacity loss. The subsequent removal of the Fe component from the amorphous metal results in a dramatic increase in capacity at all charge rates, even higher than the initial composition containing all elements. This change implies that the presence of crystalline Sn within the sample plays a dramatic role in efficient lithiation, as crystalline Sn peaks are seen in in the diffraction pattern. This composition displays consistently higher capacities over all charge rates. This more efficient lithiation additionally implies that crystalline Sn, when present within an amorphous matrix, can lithiate reversibly without dramatic irreversible capacity loss. Finally, when the Sn component is removed from the overall composition, a dramatic drop in capacity is seen over all charge rates. This indicates that Sn plays a significant role as the electrochemically active species in lithation. Removal of this species from the overall composition results in the lowest capacity of all four compositions.

To further investigate the role of Sn in the performance of these compositions, the quantity of the element within the original Si₇₈Sn₁₆Al₄Ti₂ composition was gradually increased from 4% to 94%, and the resulting capacity at the same charge rates is compared. As shown in FIG. 4B, the gradual increase in Sn content results in an increase in capacity until the 16% composition is reached, followed by a decrease in capacity as the percent Sn is raised to 94%. This change as a function of percent Sn furthers the conclusion that Sn plays an important role in lithiation within this system. As shown in FIG. 4C, the composition containing 16% Sn consistently has the highest capacity over almost all charge rates. Application of higher current densities, however, results in differing capacity trends at gradually increased Sn percent. At lower current densities, addition of Sn from 4% to 8% results in an increase in capacity with the most dramatic change occurring from 8% to 16%. At current densities higher than 400 mA/g, however, addition of Sn from 4% to 8% results in a slight drop in capacity, though 8% to 16% still results in a dramatic increase in capacity. For higher percent Sn compositions such as 78, and 94%, it is noted that at lower current densities, the 78% composition demonstrates consistently higher capacities than the 94% composition. At current densities higher than 800 mA/g, however, the 94% composition displays higher capacities than the 78% composition. It should be noted that comparatively for the higher percent compositions, the 16% Sn composition still displays higher capacity over almost all charge rates. The consistent increase for the 16% composition can be attributed to Sn acting as the central lithium storage site within the electrode. Too little Sn within the electrode results in a dramatic loss in capacity, seen in the 4%, and 8% compositions, however, addition of excess Sn results in the formation of large crystalline Sn centers, which display the severe capacity loss seen in pure Sn electrodes, rather than the microcrystalline centers within an amorphous matrix as seen in the 16% composition. The change in trends as a function of charge rate could be due to lithium's ability to diffuse throughout the electrode. At slower rates, the lithium can access the Sn centers throughout the active particles, while at higher rates only near surface Sn particles can be reached by the lithium. Regardless of charge rate, though, the 16% composition displays the highest capacity and therefore contains an amount of Sn that facilitates efficient lithiation.

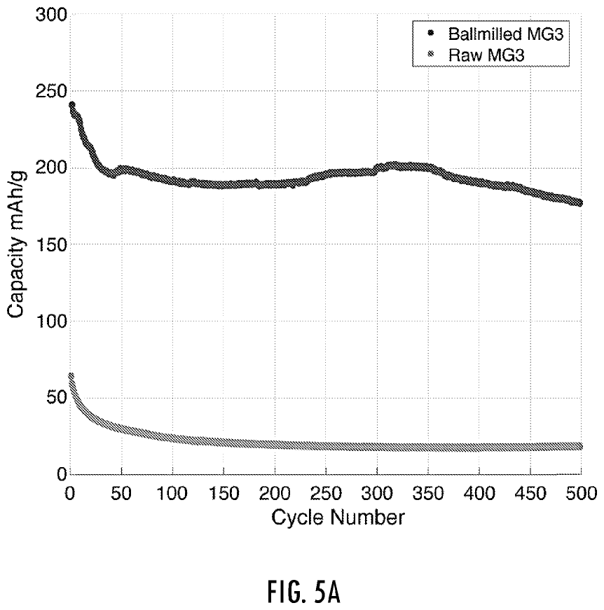

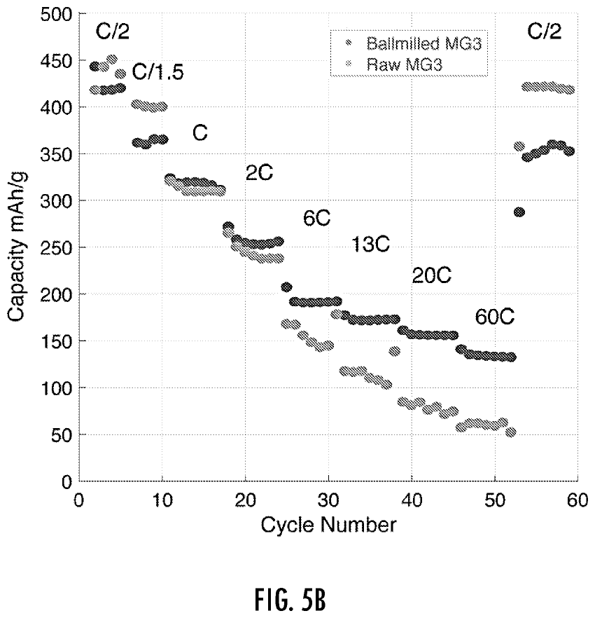

Performance of the Ball Milled Material. Comparative rate capability plots were created for the raw amorphous metal, as well as the ball milled material in order to effectively compare the performance pre- and post-processing. Long term cyclability was carried out at a current density of 1000 mA/g corresponding to a charge rate of 13C, over a period of 500 cycles. As shown in FIG. 5A, the ball milled performs better than the raw material, as it displays a considerably higher capacity over all cycles. In the first cycle, the ball milled material displayed a capacity of 240.6 mAh/g, while the raw material displayed a capacity of 63.8 mAh/g. This difference was evident throughout the 500 cycles, as the ball milled material showed a capacity of 195.4 mAh/g at the 250^{th} cycle, and 175 mAh/g at the 500^{th} cycle. Comparatively, the raw material displayed a capacity of 18.8 mAh/g at the 250^{th} cycle, and 18.14 mAh/g at the 500^{th} cycle. The ability of the processed material to display capacities more than ten times greater than the raw material over so many cycles, emphasizes the amorphous metal's ability to efficiently lithiate at fast charge rates.

To further compare the processed and unprocessed amorphous materials, the rate capability of the ball milled amorphous metal was compared to the performance of the raw amorphous metal. The comparison between the two at increasingly fast rates can be seen in FIG. 5B. Initially at relatively slow rates from C/2 to 2C, the ball milled material did not perform considerably better than the raw material. This was attributed to the fact that the slow rates allow for lithium diffusion deep into the active particles, regardless of the size of the particles. For this reason, both the ball milled and raw material can access the same amount of lithiation sites within the electrode. At fast rates, however, the processed material performs considerably better than the raw material. At fast rates of 6C to 60C, the ball milled amorphous metal performed on average, 190% better, displaying an average of 69 mAh/g more than the raw material. This was due to the considerably smaller particle sizes within the ball milled material. At faster charge rates, the lithium ions were able to diffuse through the entirety of the nanosized particles, thus reaching all of the lithiation sites within the active material. For the larger particles, however, at fast charge rates only the near-surface particles can be accessed, and therefore fewer active sites are reached, resulting in a lower capacity than the smaller particles.

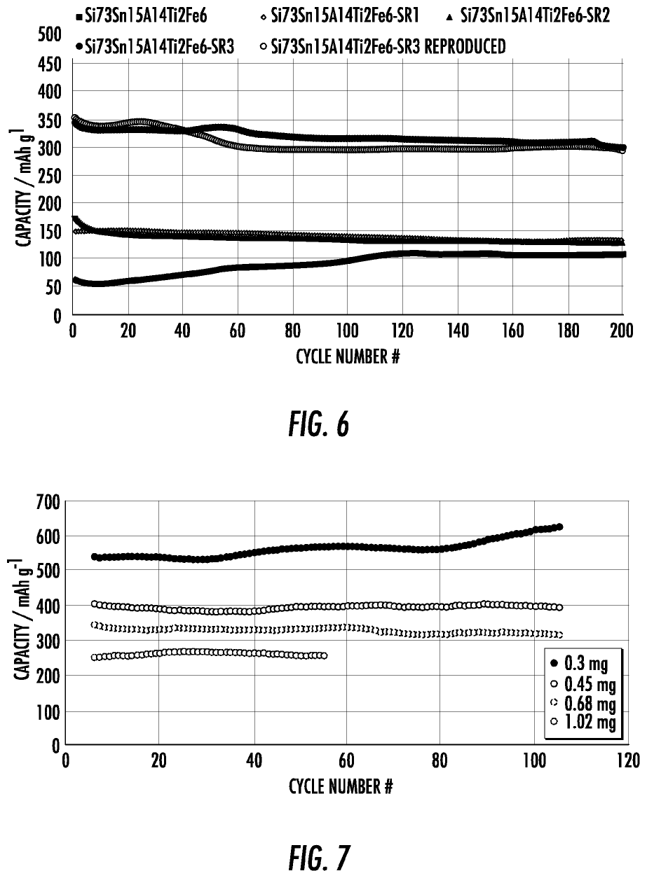

Additional Results. The performance of anodes formed using Si₇₃Sn₁₅Fe₆Al₄Ti₂ prepared using different synthetic methods. FIG. 6 is a plot showing the comparative charge/discharge cycling data of the Si₇₃Sn₁₅Al₄Ti₂Fe₆, Si₇₃Sn₁₅Al₄Ti₂Fe₆—SR1, Si₇₃Sn₁₅Al₄Ti₂Fe₆—SR2 and Si₇₃Sn₁₅Al₄Ti₂Fe₆—SR3 recorded at a current density of 6C, in a 1 mol L⁻¹ LiPF₆ in EC/DMC 1:1 V/V solution.

The effect of loading of the amorphous metal in the anodes was also assessed. Specifically, anodes were prepared using four different loadings of Si₇₃Sn₁₅Al₄Ti₂Fe₆. FIG. 7 is a plot showing the capacity of Si₇₃Sn₁₅Al₄Ti₂Fe₆—SR3 at a current density of 6C for electrodes with different mass of active material, in a 1 mol L⁻¹ LiPF₆ in EC/DMC 1:1 V/V solution. As shown in FIG. 7, capacity generally decreased as loading increased.

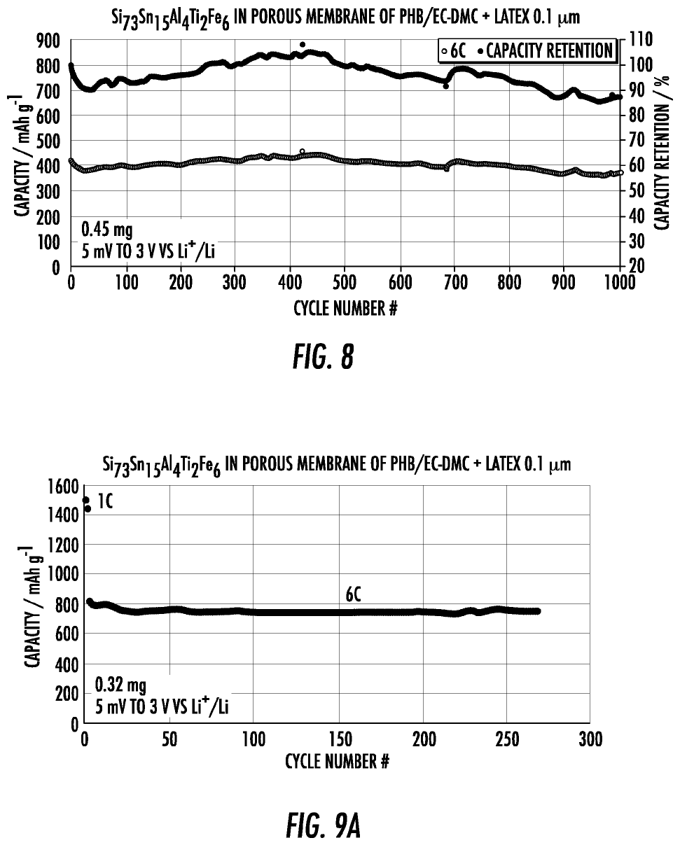

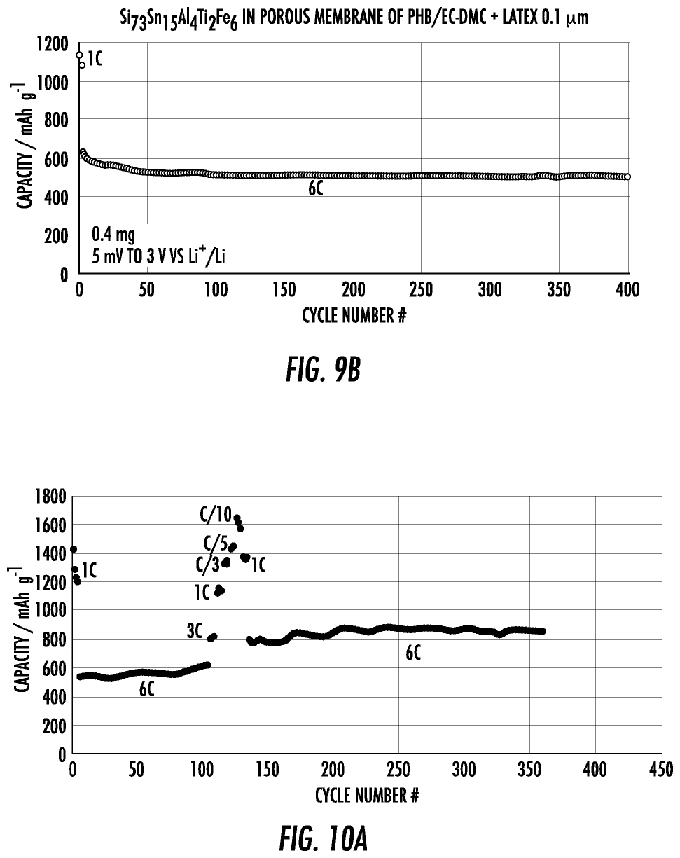

The long term cyclability of anodes formed from Si₇₃Sn₁₅Al₄Ti₂Fe₆ was also assessed. As shown in FIG. 8, FIG. 9A, and FIG. 9B, the capacity and capacity retention of Si₇₃Sn₁₅Al₄Ti₂Fe₆ remained relatively constant over 1000 cycles at current density of 6C.

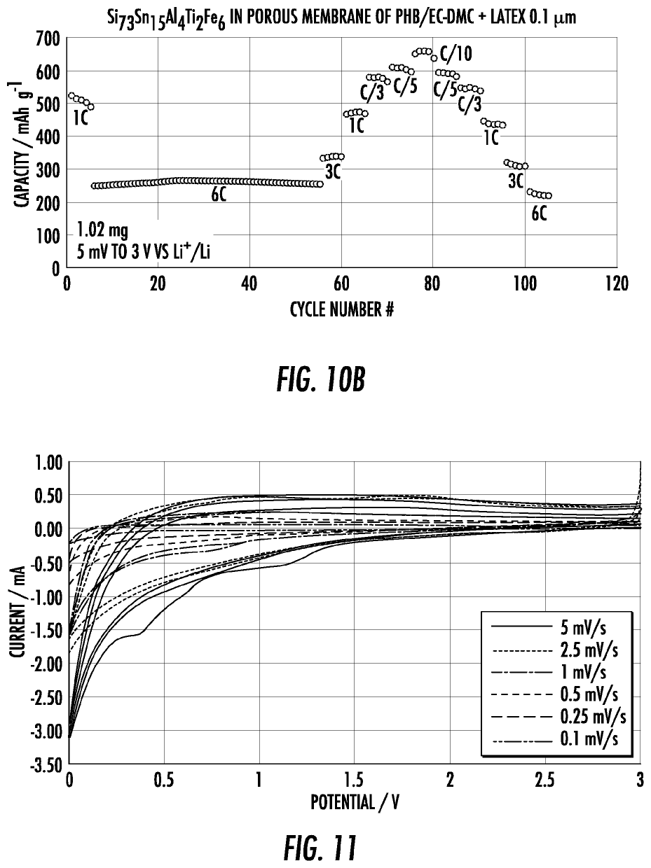

FIG. 10A and FIG. 10B show rate varying in electrodes prepared from 0.3 mg of Si₇₃Sn₁₅Al₄Ti₂Fe₆—SR3 (FIG. 10A) or 1.02 mg of Si₇₃Sn₁₅Al₄Ti₂Fe₆—SR3 (FIG. 10B) in a 1 mol L⁻¹ LiPF₆ in EC:DMC 1:1 V/V solution.

FIG. 11 shows a cyclic voltammogram for a lithium and Si₇₈Sn₁₆Al₄Ti₂ half cell, cycled at 5 mV/s, 2.5 mV/s, 1 mV/s, 0.5 mV/s, 0.25 mV/s, at 0.1 mV/s from 3 V to 0.005 V.

Electrochemical Performance of Sodium Half Cells

Though lithium ion batteries exist as the most common type of rechargeable battery, considerable research has been done on utilizing sodium as an alternative to lithium. The motivation behind this is the wide availability and accessibility of the metal. Lithium is present at low abundance, and is often unevenly distributed within the earth, meaning that it is becoming increasingly difficult to meet consumer demands. For this reason, sodium exists as an appealing alternative to lithium for rechargeable batteries. Sodium, however, presents inherent drawbacks which limit its use in commercial batteries. Its large ionic radius relative to lithium (1.02 A for Na⁺ vs. 0.76 A for Li⁺) can result in increased stress within the electrode. In addition, slower reaction kinetics resulting in lower capacities and inferior rate capability than lithium. A viable sodium anode must be able to accommodate large quantities of sodium ions without experiencing permanent deformations preventing further sodiation.

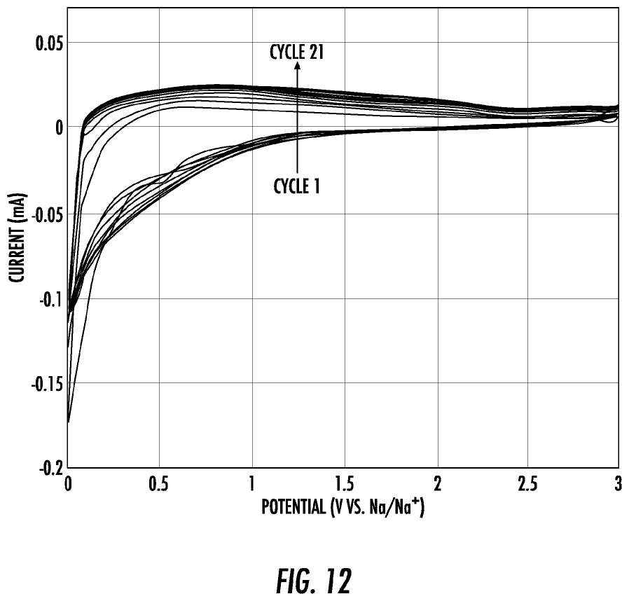

To demonstrate the amorphous metal's wide applicability, it was cycled within a sodium half cell rather than lithium. The motivation for this change was twofold. The larger ionic radius of sodium, which creates stress from expansion could be accommodated by the amorphous matrix surrounding the electrochemically active Sn clusters. In addition, Sn has been reported to reversibly alloy with sodium up to a maximum sodiation state of Na₁₅Sn₄, meaning that the electrochemically active regions of the electrode should efficiently sodiate. The cyclic voltammogram (FIG. 12) for a sodium half cell containing Si₇₈Sn₁₆Al₄Ti₂ as the cathode, cycled at a slow C/24 rate demonstrates the material's ability to sodiate reversibly. The charge passed in each cycle gradually increases with cycle number, indicating that more material is accessed as the cell is charged and discharged.

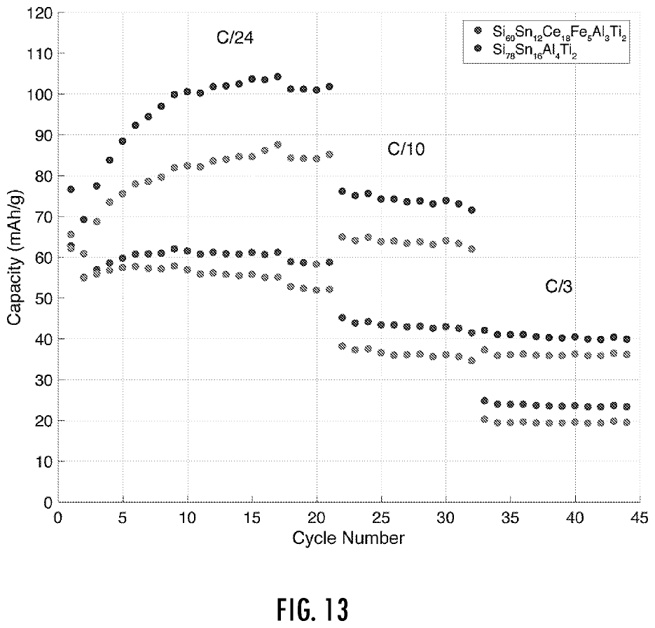

The initially tested Si₆₀Sn₁₂Ce₁₈Fe₅Al₃Ti₂ composition, as well as the optimum Si₇₈Sn₁₆Al₄Ti₂ composition were cycled at various rates in order to determine the rate capability of the amorphous metals. Two sets of each composition were cycled at rates of C/24, C/10, and C/3. The results are shown in FIG. 13. Initial cycling at C/24 displayed an increase in capacity as more material is accessed, with a maximum capacity of 104.1 mAh/g for the Si₇₈Sn₁₆Al₄Ti₂ composition, and 61.9 mAh/g for the Si₆₀Sn₁₂Ce₁₈Fe₅Al₃Ti₂ composition. Cycling at C/10 displayed a slight drop in capacity for both compositions with the maximums at 76.1 mAh/g for Si₇₈Sn₁₆Al₄Ti₂, and 45.1 mAh/g for Si₆₀Sn₁₂Ce₁₈Fe₅Al₃Ti₂. Finally, the C/3 rate also displayed a slight capacity drop with maximums at 42.0 mAh/g for Si₇₈Sn₁₆Al₄Ti₂, and 24.7 mAh/g for Si₆₀Sn₁₂Ce₁₈Fe₅Al₃Ti₂. At all rates it is evident that Si₇₈Sn₁₆Al₄Ti₂ outperforms Si₆₀Sn₁₂Ce₁₈Fe₅Al₃Ti₂. This was consistent with the findings in the lithium system, as the Sn centers within the amorphous matrix act as the main lithium, and sodium storage sites, suggesting that both should be able to reversibly alloy with minimum capacity loss.

Electrochemical Performance of Full Cells

Lithium Iron Phosphate. Once the performance of the amorphous metal within a half cell is established, the material was used as an anode within a full cell setup. Rather than using lithium metal as the counter/reference and the amorphous metal as the working electrode, the alloy was used as the counter and reference electrode, while a variety of popular commercial materials are used as working electrodes. Popular commercial cathodes used in the full cells were lithium iron phosphate (LiFePO₄), NMC, and NCA. These materials have been established as reliable cathodes providing reasonable capacity and excellent cyclability, and therefore were selected to pair with the amorphous metal to determine the performance of a full cell.

LiFePO₄ is considered a popular candidate as a cathode material for future generation lithium ion batteries long term cyclability, low toxicity, and high natural resource abundance. In addition to these advantages, LiFePO₄ has been considered for possible fast charging applications, and has demonstrated the ability to fully charge at rates greater than 6C. LiFePO₄ exists as the most popular material is the polyanionic compound class of cathodes. Upon lithiation of the cathode material, lithium ions diffuse through channels along the [010] direction creating simple 1D lithium transport pathways. LiFePO₄ demonstrates thermal stability better than the standard Lithium Cobalt Oxide commercial cathode, as well as higher power capabilities. Therefore, in order to demonstrate the amorphous metal's ability to cycle when paired with a cathode, LiFePO₄ was selected as the initial material to pair.

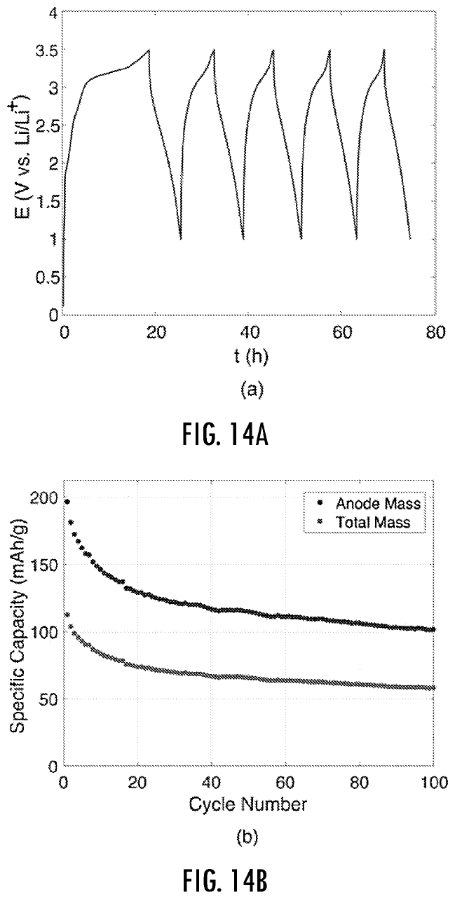

To begin testing of the full cell setup, a potential range of 3.5V-1V was selected for chronopotentiometric testing. Cycling within this potential range demonstrated stable performance, with an initial cycle forming SEI products, followed by stable charge/discharge cycles. As shown in FIG. 14A, the initial charge cycle contains plateaus associated with formation of SEI products, while all subsequent charge and discharge cycles show similar shapes. This implies that the cell operates within the initial potential range of 3.5V-1V.

The resulting specific capacity for the full cell in this potential window can be seen in FIG. 14B. The capacity was normalized both to the mass of the active material present in the anode, and to the sum of the active masses in both the anode and the cathode. In the cell, the mass of active material of the cathode was in excess, ensuring that sufficient charge could be stored in the cathode, to fully charge the anode. The capacity normalized to the mass of the anode demonstrated an initial capacity of 196.3 mAh/g, though a considerable drop in capacity was seen as 42% of capacity is lost by the 50th cycle resulting in a capacity of 114.5 mAh/g, while 48% of capacity was lost by the 100th cycle resulting in a capacity of 101.4 mAh/g.

Chronopotentiometric cycling within the window of 3.5V-1V demonstrated the ability of LiFePO₄ and the amorphous metal to cycle continuously without immediate deterioration of the electrodes and subsequent cell death. Due to these results, the potential window is opened from 3.5V-1V to 4.5V-5 mV, thus dramatically widening the operating window by 2V. Opening the potential window introduces several advantages to the performance of the battery. The larger range allows for more potential to charge and discharge, potentially leading to higher specific capacities, and the higher voltage ultimately leads to increased power within the cell. This can be beneficial for certain applications, which require higher power densities such as power tools, transportation systems, and medical devices.

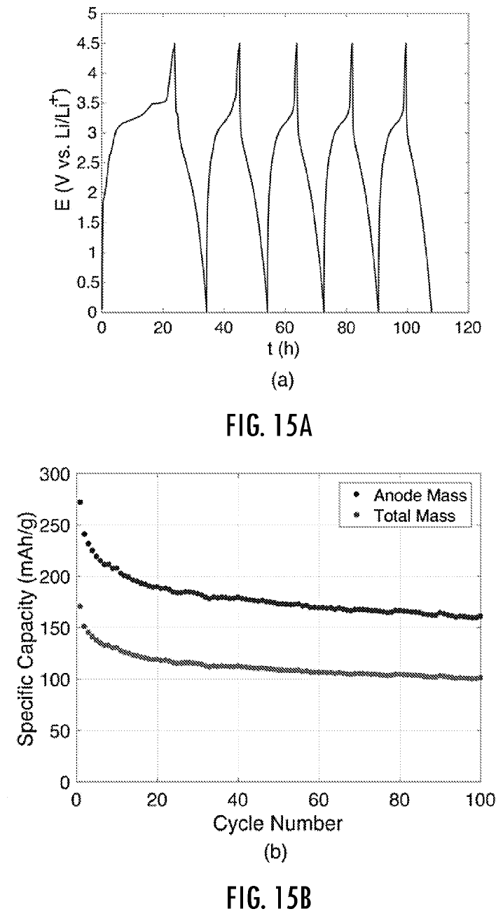

Initial chronopotentiometric cycling within the new potential window, seen in FIG. 15A, demonstrated an initial charge cycle with distinct plateaus at 3.1 V, and at 3.5 V. Subsequent cycles demonstrated plateaus at 3.2 V on charging cycles, and 2.7 V on discharging cycles, while no plateaus were visible below 2.5 V. These plateaus could be attributed to phase formations in the LiFePO₄ cathode, where lithium incorporates into the lattice network. However below 2.5 V in the region where the anode would lithiate, no phase formations were visible, again implying that the anode maintains an amorphous structure through lithation.

The performance of the cells in the new potential region, seen in FIG. 15B, were again normalized to the masses of just the anode, as well as the anode an initial capacity of 271.7 mAh/g, with a 37% drop by the 50th cycle resulting in a capacity of 172.7 mAh/g, and a 420% capacity drop by the 100th cycle resulting in a capacity of 160.7 mAh/g. When normalized to the sum of the masses of the anode and cathode, the cell demonstrated an initial capacity of 170.4 mAh/g, with a 37% drop by the 50th cycle resulting in a capacity of 108.3 mAh/g, and a 41% capacity drop by the 100th cycle resulting in a capacity of 100.8 mAh/g.

Using LiFePO₄ as the cathode material demonstrates cyclability within both potential windows, and therefore the wider window allows for a greater power density within the cells. When considering the power density for each potential window, the initial range of 3.5 V-1 V provides a density of 490.8 Wh/kg in the initial cycle, which drops to 286.3 Wh/kg by the 50th cycle, and 253.5 Wh/kg by the 100th cycle. Comparatively, in the window of 4.5 V-5 mV, the cell provides an initial power density of 1221.3 Wh/kg, dropping to 776.3 Wh/kg by the 50th cycle, and 722.3 Wh/kg by the 100th cycle. Opening of the potential window allows not only for an increase in specific capacity, but additionally an increase in power density. By opening the potential window, the specific capacity increases on average by 149%, while the power density increases by 268%. The ability of this cell to cycle in the wider window demonstrates its ability to operate as a potential energy source for high power applications.

NMC and NCA. Although the use of polyanionic compounds in cathodes has been considered, transition metal oxides exist as the most popular class of cathode materials, with LiCoO₂ being the first and most commercially successful. LiCoO₂ has been extremely popular due to its high theoretical capacity of 274 mAh/g, and excellent cycling performance, however, it does display inherent limitations. The major limitation of LiCoO₂ is the low natural abundance, high cost, and relatively high toxicity of cobalt, which makes up a sizeable portion of the cathode composition, as well as poor thermal stability. As a result of these limitations, substitutions into the lattice have been made to reduce the cobalt content in the overall composition. It was observed that doping with nickel and Al can improve the thermal stability and electrochemical performance of the cathode. The result of these substitutions is the LiNi_{0.8}Co_{0.15}Al_{0.05}O₂ (NCA) cathode, which exhibits a high discharge capacity of 200 mAh/g, exists as a popular alternative to LiCoO₂ due to the considerably lower cobalt content.

In addition to NCA, cobalt substituted into LiNi_{0.5}Mn_{0.5}O₂ resulting in LiNiₓCo_{y}Mn_{z}O₂ (x=0.33, 0.68, 0.80; y=0.33, 0.18, 0.10; z=0.33, 0.18, 0.1) (NMC), which also exists as a popular commercial alternative to LiCoO₂ as it displays a reversible specific capacity of 234 mAh/g. This commercial cathode is capable of high voltage operation in regions as high as 4.5 V, while maintaining good cyclability at rates as high as 6C. For these reasons, NMC and NCA were chosen as additional cathodes to pair with the amorphous metal anode in order to further confirm the viability of the anode as a potential commercial candidate. Through cycling, NMC and NCA both display higher operating voltage regions than LiFePO₄, allowing for half cells to be cycled as high as 4.5 V. For this reason, the wider potential window used in LiFePO₄ cycling were applied to NMC and NCA cells paired with the amorphous metal anode.

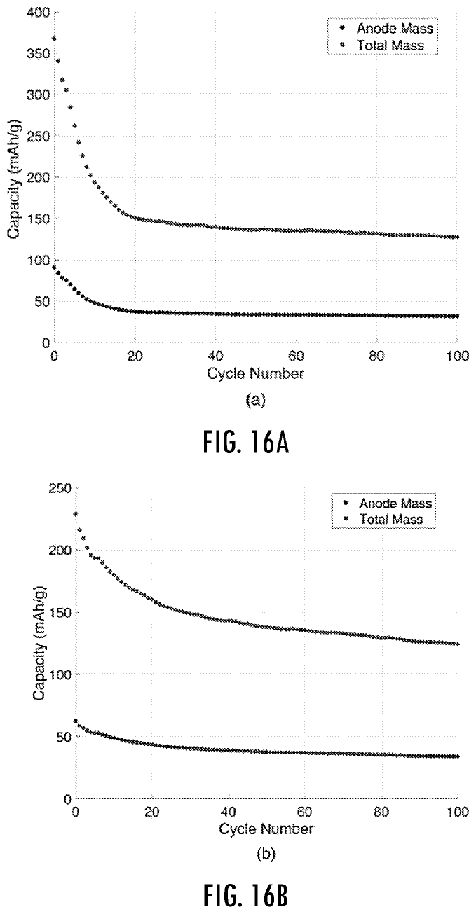

The cycling performance for the NMC full cell, seen in FIG. 16A when normalized to the mass of the anode demonstrates an initial capacity of 228.6 mAh/g with a 40% loss by the 50th cycle resulting in a capacity of 137.7 mAh/g, and a 46% loss by the 100th cycle resulting in a capacity of 124.1 mAh/g. Alternatively, the NCA full cell, seen in FIG. 16B, when normalized to the mass of the anode displays an initial capacity of 366.9 mAh/g with a 63% drop by the 50th cycle resulting in a capacity of 135.6 mAh/g, and a 65% drop by the 100th cycle, resulting in a capacity of 127.3 mAh/g. Although the NMC and NCA cells both display a sizeable capacity drop over 100 cycles, it is noted that the capacity stabilizes after the 20th cycle. For the NCA full cell, the capacity only drops 6% from the 20th to the 100th cycle, while the NMC cell drops 15 from the 20th to the 100th cycle. This initial drop could be attributed to the large size of the active material particles in the anode, which would hinder the lithium ion's ability to diffuse out of the solid. By decreasing the size of the active particles, this dramatic drop in the first cycles could potentially be diminished.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

What is claimed is:

1. An anode comprising particles formed from an amorphous glass formed from a mixture comprising two or more active components and two or more amorphous forming components.

2. The anode of claim 1, wherein the particles comprise a population of microparticles.

3. The anode of claim 2, wherein the population of microparticles has an average particle size of from 1 micron to 15 microns, such as from 1 micron to 5 microns, as determined by scanning electron microscopy (SEM).

4. The anode of claim 1, wherein the particles comprise a population of nanoparticles.

5. The anode of claim 4, wherein the population of nanoparticles has an average particle size of from 25 nm to less than 1 micron, such as from 100 nm to 750 nm, as determined by scanning electron microscopy (SEM).

6. The anode of any of claims 1-5, wherein the particles comprise a monodisperse population of particles.

7. The anode of any of claims 1-6, wherein the two or more active components comprise from 51 mol % to 99 mol % of the amorphous glass, such as from 80 mol % to 95 mol % of the amorphous glass.

8. The anode of any of claims 1-7, wherein the two or more amorphous forming components comprise from 1 mol % to 49 mol % of the amorphous glass, such as from 5 mol % to 25 mol % of the amorphous glass or from 5 mol % to 20 mol % of the amorphous glass.

9. The anode of any of claims 1-8, wherein the two or more active components and two or more amorphous forming components are present in the amorphous glass at a molar ratio of from 1.1:1 to 50:1, such as from 1.1:1 to 25:1, from 2:1 to 25:1, from 2:1 to 20:1, from 4:1 to 20:1, from 5:1 to 15:1, or from 5:1 to 10:1.

10. The anode of any of claims 1-9, wherein the two or more active components comprise silicon, tin, lead, antimony, germanium, gallium, indium, bismuth, or any combination thereof.

11. The anode of any of claims 1-10, wherein the two or more active components can comprise silicon.

12. The anode of any of claims 1-11, wherein the two or more active components can comprise tin.

13. The anode of any of claims 1-12, wherein the amorphous glass comprises a SiSn-based glass.

14. The anode of claim 13, wherein the two or more active components comprise silicon and tin, and wherein the silicon and the tin are present a molar ratio of from 1.1:1 to 20:1, such as from 2:1 to 15:1 or from 3:1 to 12:1.

15. The anode of any of claims 1-14, wherein the two or more amorphous forming components comprise iron, aluminum, titanium, copper, nickel, cobalt, manganese, zirconium, yttrium, boron, niobium, molybdenum, tungsten, or any combination thereof.

16. The anode of any of claims 1-15, wherein the two or more amorphous forming components comprise one or more lanthanides.

17. The anode of claim 16, wherein the one or more lanthanides comprise from 1 mol % to 25 mol % of the amorphous glass, such as from 5 mol % to 20 mol % of the amorphous glass or from 10 mol % to 20 mol % of the amorphous glass.

18. The anode of any of claims 1-17, wherein the two or more amorphous forming components comprise one or more Group 4 elements.

19. The anode of claim 18, wherein the one or more Group 4 elements comprise from 1 mol % to 15 mol % of the amorphous glass, such as from 1 mol % to 10 mol % of the amorphous glass or from 2 mol % to 8 mol % of the amorphous glass.

20. The anode of any of claims 1-19, wherein the two or more amorphous forming components comprise one or more Group 13 elements.

21. The anode of claim 20, wherein the one or more Group 13 elements comprise from 1 mol % to 8 mol % of the amorphous glass, such as from 2 mol % to 6 mol % of the amorphous glass or from 3 mol % to 4 mol % of the amorphous glass.

22. The anode of any of claims 1-21, wherein the amorphous glass comprises a glass defined by the formula below
SiₓSn_{y}¹AFMₐ²AFM_{b}³AFM_{c}⁴AFM_{d}
wherein
¹AFM, ²AFM, ³AFM, and ⁴AFM represent different elements, each chosen from iron, aluminum, titanium, copper, nickel, cobalt, manganese, gallium, indium, zirconium, and yttrium;
x is from 50 to 90;
y is from 1 to 40;
a is from 0.5 to 20;
b is from 0.5 to 15;
c is from 0 to 10; and
d is from 0 to 10.

23. The anode of any of claims 1-22, wherein the amorphous glass comprises a SiSnCeFeAlTi glass, such as Si₆₀Sn₁₂Ce₁₈Fe₅Al₃Ti₂.

24. The anode of any of claims 1-22, wherein the amorphous glass comprises a SiSnFeAlTi glass, such as Si₇₃Sn₁₅Fe₆Al₄Ti₂.

25. The anode of any of claims 1-22, wherein the amorphous glass comprises a SiSnAlTi glass, such as Si₇₈Sn₁₆Al₄Ti₂.

26. The anode of any of claims 1-25, wherein the particles are formed by ball milling.

27. The anode of any of claims 1-25, wherein the particles are formed by a templating process.

28. The anode of claim 27, wherein the templating process employs a porous membrane as a template to control particle size.

29. The anode of any of claims 27-28, wherein templating process comprises:
imbibing a precursor solution comprising a metal precursor into a template; and
calcining the template.

30. The anode of any of claims 1-29, wherein the particles have an aspect ratio of 10 or less, such as an aspect ratio of 5 or less or an aspect ratio of 2 or less.

31. The anode of any of claims 1-30, wherein the two or more amorphous forming components comprise inactive components.

32. The anode of any of claims 1-31, wherein the particles further comprise a carbonaceous material disposed on a surface of the particles.

33. The anode of any of claims 1-32, wherein the particles are dispersed in a binder.

34. The anode of claim 33, wherein the binder comprises a polymeric binder such as vinylidene fluoride (PVDF), polyaniline, or a combination thereof.

35. The anode of any of claims 33-34, wherein the binder comprises a conductive polymer.

36. The anode of any of claims 33-35, wherein the binder comprises a carbonaceous material such as carbon black.

37. The anode of any of claims 1-36, wherein the particles can react with and store working ions selected from the group consisting of lithium ions, sodium ions, potassium ions, or a combination thereof under conditions typically encountered during charging and discharging of a battery comprising the working ions.

38. An electrochemical cell comprising the anode of any of claims 1-37, a cathode, and an electrolyte disposed between the anode and the cathode.

39. The electrochemical cell of claim 38, wherein the electrochemical cell comprises a lithium ion battery, and wherein the cathode comprises a lithium-based cathode.

40. The electrochemical cell of claim 39, wherein the cathode comprises lithium iron phosphate, LiNi₁₋ₓMn_{x/2}Coₓ/2O₂, wherein x=0.4 or 0.2, or LiNi_{0.8}Co_{1.15}Al_{0.05}O₂.

41. The electrochemical cell of any of claims 39-40, wherein the electrochemical cell exhibits an energy density of at least 180 Wh/kg at room temperature, such as an energy density of from 180 Wh/kg to 3,500 Wh/kg at room temperature.

42. The electrochemical cell of any of claims 38-41, wherein the electrochemical cell exhibits a charge rate of from 1 minute to 10 minutes to 30% of a state of charge (SOC), a charge rate of from 1 minute to 10 minutes to 50% of a state of charge (SOC), a charge rate of from 1 minute to 10 minutes to 70% of a state of charge (SOC), and/or a charge rate of from 1 minute to 10 minutes to 90% of a state of charge (SOC).

43. A population of particles formed from an amorphous glass, the amorphous glass comprising a glass defined by the formula below
SiₓSn_{y}¹AFMₐ²AFM_{b}³AFM_{c}⁴AFM_{d}
wherein
¹AFM, ²AFM, ³AFM, and ⁴AFM represent different elements, each chosen from iron, aluminum, titanium, copper, nickel, cobalt, manganese, gallium, indium, zirconium, and yttrium;
x is from 50 to 90;
y is from 1 to 40;
a is from 0.5 to 20;
b is from 0.5 to 15;
c is from 0 to 10; and
d is from 0 to 10.

44. The population of claim 43, wherein the population of particles comprises a population of microparticles.

45. The population of claim 44, wherein the population of microparticles has an average particle size of from 1 micron to 15 microns, such as from 1 micron to 5 microns, as determined by scanning electron microscopy (SEM).

46. The population of claim 43, wherein the population of particles comprises a population of nanoparticles.

47. The population of claim 46, wherein the population of nanoparticles has an average particle size of from 25 nm to less than 1 micron, such as from 100 nm to 750 nm, as determined by scanning electron microscopy (SEM).

48. The population of any of claims 43-47, wherein the population of particles is monodisperse in size.

49. The population of any of claims 43-48, wherein the particles have an aspect ratio of 10 or less, such as an aspect ratio of 5 or less or an aspect ratio of 2 or less.
